(19) United States
(12) Patent Application Publication
(10) Pub. No.: US 2019/0228461 A1
(43) Pub. Date: Jul. 25, 2019

(54) Omnichannel Commerce Platform with Integrated Mobile Shopping Platform, Online Shopping Platform, Commerce Data and Blockchain Layer

(71) Applicants: Marius Keeley Domokos, Palo Alto, CA (US); Babak Bobby Marhamat, Mountain View, CA (US)

(72) Inventors: Marius Keeley Domokos, Palo Alto, CA (US); Babak Bobby Marhamat, Mountain View, CA (US)

(21) Appl. No.: 15/879,445

(22) Filed: Jan. 25, 2018

(51) Int. Cl. G06Q 30/06; G06Q 30/02; G06Q 20/32; G06Q 20/36

(52) U.S. Cl. CPC G06Q 30/0641; G06Q 30/0201; G06Q 30/0613; G06Q 20/367; G06Q 20/3223

(57) ABSTRACT

Methods, systems and computer program products for implementing an omnichannel commerce platform adapted to facilitate commerce transactions.

### CROSS-REFERENCE

None.

### BACKGROUND

Small and Medium Business (SMB) merchants and Enterprises involved in physical commerce have been under competitive pressure from online merchants. Reasons for this include that some online merchants have been able to offer advanced, comprehensive and more uniform shopping experiences for consumers while benefiting from lower operational costs. Also, the technologies available to physical commerce merchants often lag behind those deployed online and have inferior analytical capabilities. Additionally, the cost of adopting and deploying more advanced commerce features, to the extent available, tend to exceed the budgets of most SMB merchants and many Enterprise merchants.

Consequently, there is a significant need in the industry for improved commerce platforms with comprehensive omnichannel features, better data analytics, lower adoption costs, and innovative blockchain and cryptocurrency functionality that can be deployed broadly by SMBs and Enterprises involved in physical commerce, can facilitate novel approaches to commerce, and can improve engagements with consumers.

### SUMMARY

Various example embodiments describe systems, methods and computer program products for implementing an omnichannel commerce platform adapted to facilitate commerce transactions (including the ordering, purchase, sale, lease and/or license of goods and services) using payment transactions, blockchain functionality, smart contracts, cryptocurrencies, cryptographic tokens, omnichannel features, commerce data collection and management, commerce data analytics, monetization of commerce data, commerce data analytics, and/or any combination of the foregoing.

According to one embodiment, an omnichannel commerce platform comprises an omnichannel layer adapted to facilitate a commerce transaction between a merchant and a data processing system in possession of a consumer and a data management and analytics layer that stores commerce data. In accordance with this embodiment, the omnichannel layer and the data management and analytics layer are connected to each other and are each connected to an API layer. In accordance with this embodiment, at least one of the omnichannel layer and the data management and analytics layer is adapted to make the commerce data available to be used in the course of the commerce transaction.

In accordance with an embodiment, an omnichannel layer, a data management and analytics layer and a data processing system are adapted to communicate with each other via an API layer, via a network, or via a combination of the API layer and a network.

In accordance with an embodiment, at least one of an omnichannel layer and a data management and analytics layer is adapted to update at least a subset of commerce data based on a commerce transaction.

In accordance with an embodiment, an omnichannel layer is adapted to receive from a data management and analytics layer and/or from a data processing system a set of consumer data relating to a consumer.

In accordance with an embodiment, a commerce transaction includes a payment made via a credit card or debit card, and an omnichannel commerce platform is adapted to route a payment to a payment processor. In accordance with an embodiment, a payment processor does not have a pre-existing relationship with the merchant.

In accordance with an embodiment, an omnichannel layer includes a mobile app shopping platform, a mobile app shopping platform is adapted to facilitate a commerce transaction, and a data processing system in possession of the consumer is any of the following: a mobile phone running an app, including any mobile phone that utilizes an iOS, Android, or Windows operating system; an electronic tablet running an app, including any electronic tablet that utilizes an iOS, Android, or Windows operating system; a wearable device running an app, including an electronic watch with a digital display, or an electronic eyewear device; a vehicle entertainment system running an app, vehicle navigation system, or vehicle information system; or a laptop or other personal computer running an app.

In accordance with an embodiment, an omnichannel layer includes an online shopping platform, the online shopping platform is adapted to facilitate a commerce transaction, and a data processing system in possession of the consumer may be any of the following: a mobile phone running an app or a browser adapted to communicate with the online shopping platform, including any mobile phone that utilizes an iOS, Android, or Windows operating system; an electronic tablet running an app or a browser adapted to communicate with the online shopping platform, including any electronic tablet that utilizes an iOS, Android, or Windows operating system; a wearable device running an app or a browser adapted to communicate with the online shopping platform, including an electronic watch with a digital display, or an electronic eyewear device; a vehicle entertainment system running an app or a browser adapted to communicate with the online shopping platform, vehicle navigation system, or vehicle information system; or a laptop or other personal computer running an app or a browser adapted to communicate with the online shopping platform.

In accordance with an embodiment, commerce data used in the course of a commerce transaction may include any of the following: consumer data; merchant data; vendor data; deliveries data; reservations data; other omnichannel data; or key performance indicators (KPIs) and other analytics based on any of the foregoing.

In accordance with an embodiment, a commerce transaction may include one or more of the following: purchase or sale of a food item or beverage item; purchase or sale of a retail item; purchase or sale of fuel for a vehicle, including gasoline, natural gas, liquefied natural gas, Hydrogen, or a fuel cell; charging of an electric or hybrid vehicle; purchase or sale of an item in a grocery store; a rental transaction from a hotel or other lodging facility; rental of a car or other vehicle; purchase or sale of a ticket for travel; purchase or sale of a ticket for an event; a transaction involving a service provided by a Governmental agency; a bank transaction; a sale, purchase or transfer of cryptocurrency; a sale, purchase or transfer of a classic currency; or a conversion between one or more cryptocurrencies and/or one or more classic currencies.

According to one embodiment, a method for conducting a commerce transaction between a merchant and a data processing system in possession of a consumer uses an omnichannel commerce platform, and the omnichannel commerce platform may include an omnichannel layer adapted to facilitate the commerce transaction and a data management and analytics layer that stores commerce data.

In accordance with an embodiment, the omnichannel layer and the data management and analytics layer may be connected to each other and to an API layer.

In accordance with an embodiment, the commerce data may be used in connection with the commerce transaction.

In accordance with an embodiment, the commerce data used in connection with the commerce transaction may be received via the API layer, via a network, or via a combination of the API layer and a network.

In accordance with an embodiment, at least a subset of the commerce data may be updated based on the commerce transaction.

In accordance with an embodiment, the omnichannel layer may receive in connection with the commerce transaction a set of consumer data relating to the consumer from the data management and analytics layer and/or from the data processing system.

In accordance with an embodiment, the commerce transaction may include routing a payment made via a credit card or debit card to a payment processor.

In accordance with an embodiment, the payment processor may not have a pre-existing relationship with the merchant.

In accordance with an embodiment, the commerce transaction may be conducted via a mobile app shopping platform included in the omnichannel layer, and the data processing system in possession of the consumer may be any of the following: a mobile phone running an app, including any mobile phone that utilizes an iOS, Android, or Windows operating system; an electronic tablet running an app, including any electronic tablet that utilizes an iOS, Android, or Windows operating system; a wearable device running an app, including an electronic watch with a digital display, or an electronic eyewear device; a vehicle entertainment system running an app, vehicle navigation system, or vehicle information system; or a laptop or other personal computer running an app.

In accordance with an embodiment, the commerce transaction may be conducted via an online shopping platform included in the omnichannel layer, and the data processing system in possession of the consumer may be any of the following: a mobile phone running an app or a browser adapted to communicate with the online shopping platform, including any mobile phone that utilizes an iOS, Android, or Windows operating system; an electronic tablet running an app or a browser adapted to communicate with the online shopping platform, including any electronic tablet that utilizes an iOS, Android, or Windows operating system; a wearable device running an app or a browser adapted to communicate with the online shopping platform, including an electronic watch with a digital display, or an electronic eyewear device; a vehicle entertainment system running an app or a browser adapted to communicate with the online shopping platform, vehicle navigation system, or vehicle information system; or a laptop or other personal computer running an app or a browser adapted to communicate with the online shopping platform.

In accordance with an embodiment, the commerce data may include one or more of the following: consumer data; merchant data; vendor data; deliveries data; reservations data; other omnichannel data; or key performance indicators (KPIs) and other analytics based on any of the foregoing.

In accordance with an embodiment, the commerce transaction may include one or more of the following: purchase or sale of a food item or beverage item; purchase or sale of a retail item; purchase or sale of fuel for a vehicle, including gasoline, natural gas, liquefied natural gas, Hydrogen, or a fuel cell; charging of an electric or hybrid vehicle; purchase or sale of an item in a grocery store; a rental transaction from a hotel or other lodging facility; rental of a car or other vehicle; purchase or sale of a ticket for travel; purchase or sale of a ticket for an event; a transaction involving a service provided by a Governmental agency; a bank transaction; a sale, purchase or transfer of cryptocurrency; a sale, purchase or transfer of a classic currency; or a conversion between one or more cryptocurrencies and/or one or more classic currencies.

This Summary section is provided to introduce a selection of concepts at a higher overview level, but is not specifically intended to identify key features, essential applications, or better implementations of the claimed subject matter. Consequently, nothing in this Summary section may be used to limit the scope of the claimed subject matter presented in the Claims.

### INCORPORATION BY REFERENCE

All publications, patents, and patent applications mentioned herein, if any, are incorporated by reference to the same extent as if each such individual publication, patent, or patent application were specifically and individually indicated to be incorporated by reference. To the extent that any inconsistency or conflict may exist between information expressly disclosed herein and information disclosed in any publications, patents, or patent applications that are incorporated by reference in this patent, the information expressly disclosed in this patent application (or patent, upon issuance) will take precedence and prevail.

### BRIEF DESCRIPTION OF THE DRAWINGS

The accompanying figures, which together with the detailed description below are incorporated in and form part of the specification, serve to further illustrate various embodiments and to explain various principles and advantages all in accordance with example embodiments of the present inventions.

FIG. 1 shows an exemplary architecture of an omnichannel commerce platform in accordance with an embodiment.

FIG. 2 shows a representation of an exemplary data processing system 200 that may be used in connection with various embodiments and that may be configured to execute instructions for performing functions and methods described and/or claimed in connection with various embodiments.

FIG. 3 shows an omnichannel commerce platform adapted to facilitate commerce transactions between a set of consumers and a set of merchants, in accordance with an embodiment.

FIG. 4 shows an example of an ordering environment for a restaurant, together with an example flow of an order placed by a consumer via a mobile app running on a data processing system associated with the consumer (e.g., on a mobile phone), in accordance with an embodiment.

FIG. 5 shows an order management system that allows a merchant to visualize orders placed by consumers both remotely and locally, in accordance with an embodiment.

FIG. 6 shows an omnichannel commerce platform adapted to make available an ordering environment of a merchant to multiple consumers, where the ordering environment is customized for one or more of the consumers, in accordance with an embodiment.

FIG. 7 shows an omnichannel commerce platform adapted to process and transmit commerce data and/or commerce data analytics to one or more data customers, in accordance with an embodiment.

FIG. 8 shows an omnichannel commerce platform adapted to process a commerce transaction between a consumer and a merchant by selecting a payment processor from a set of payment processors, in accordance with an embodiment.

### DETAILED DESCRIPTION

While the specification concludes with claims defining the features of the invention that are regarded as novel, the invention will be better understood from a consideration of the following description in conjunction with the drawing figures, in which like reference numerals are carried forward.

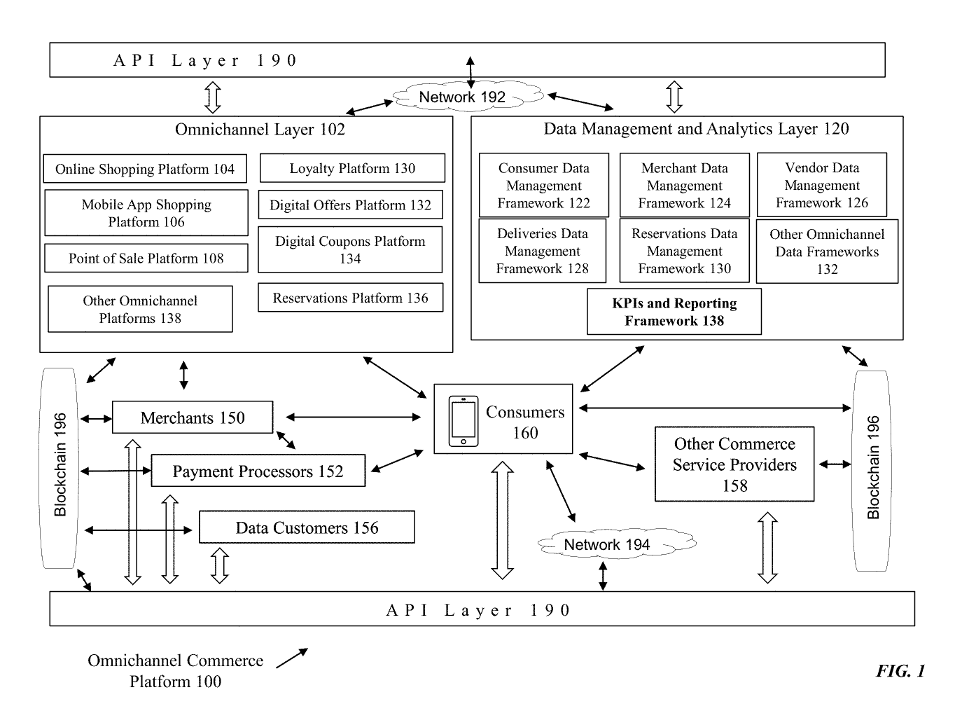

FIG. 1 shows an exemplary architecture of an omnichannel commerce platform in accordance with an embodiment.

The exemplary omnichannel commerce platform 100 illustrated in the embodiment of FIG. 1 includes an omnichannel layer 102 and a data management and analytics layer 120 connected to an API layer 190.

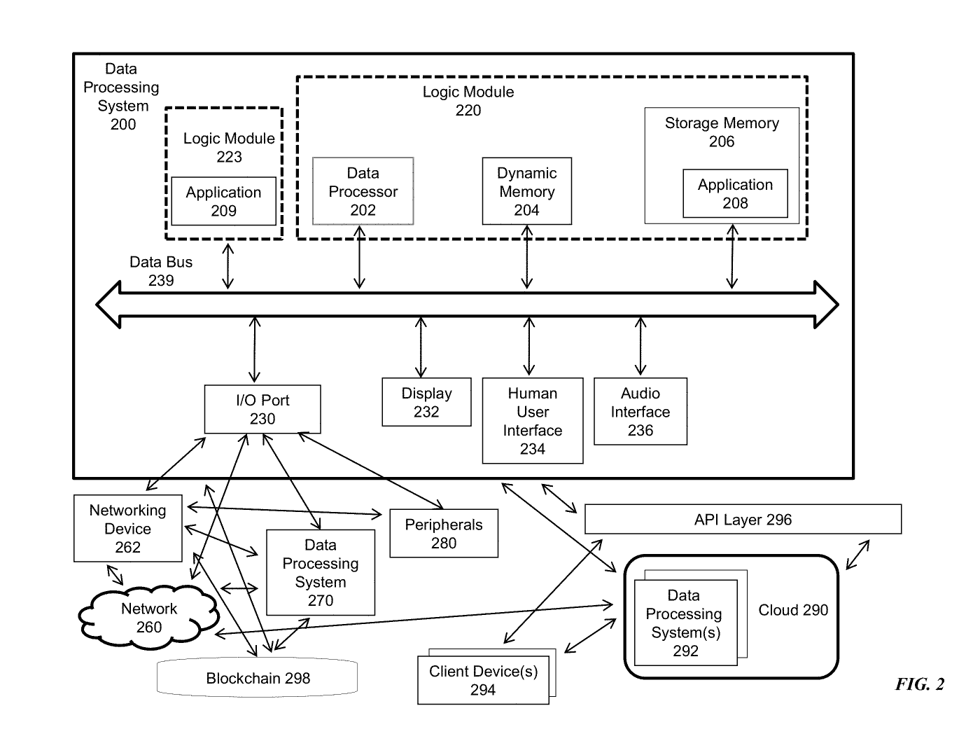

In various embodiments, each of the consumers 160 may communicate using a data processing system, such as a mobile phone, mobile tablet, personal computer, laptop, or any other data processing system, such as the data processing systems discussed in connection with FIG. 2.

In one embodiment, the omnichannel layer 102 comprises one or more platforms adapted to provide functionality for commerce transactions. Examples of such platforms that may be included in an omnichannel layer, such as the omnichannel layer 102, include an online shopping platform 104, a mobile app shopping platform 106, a point of sale platform 108, a loyalty platform 110, a digital offers platform 112, a digital coupons platform 114, a reservations platform 116, and other platforms with omnichannel functionality denoted in the embodiment of FIG. 1 as other omnichannel platforms 118.

In various embodiments, two or more of the online shopping platform 104, mobile app shopping platform 106, point of sale platform 108, loyalty platform 110, digital offers platform 112, digital coupons platform 118, reservations platform 116, and other omnichannel platforms 118 communicate with each other via an API layer, such as the API layer 190, and/or otherwise via a communication channel or network.

In one embodiment, the data management and analytics layer 120 comprises one or more data frameworks adapted to store, manage, analyze, and communicate to other components the omnichannel commerce platform 100 commerce data. Examples of such data frameworks that may be included in a data management and analytics layer, such as the data management and analytics layer 120, include the consumer data management framework 122, merchant data management framework 124, vendor data management framework 126, deliveries data management framework 128, reservations data management framework 130, one or more of the other omnichannel data frameworks 132, and/or the KPIs and reporting framework 138. In various embodiments, each of these data frameworks included in the data management and analytics layer 120 may include one or more databases for storing commerce data and/or cloud computational resources to store and process commerce data.

In various embodiments, two or more of consumer data management framework 122, merchant data management framework 124, vendor data management framework 126, deliveries data management framework 128, reservations data management framework 130, one or more of the other omnichannel data frameworks 132, and/or the KPIs and reporting framework 138 communicate with each other via an API layer, such as the API layer 190, and/or otherwise via a communication channel or network.

In one embodiment, the API layer 190 from FIG. 1 may be, or may include the API layer 296 from the embodiment of FIG. 2. In various embodiments, the API layer 190 may include common and/or dedicated APIs that allow various components of the omnichannel commerce platform 100 to receive data, including commerce data. In various embodiments, the API layer 190 may facilitate commerce data communications between the omnichannel layer 102, the data management and analytics layer 120, a set of merchants 150, a set of payment processors 152, a set of data customers 156, one or more commerce service providers 158, and/or a set of consumers 160.

In various embodiments, communications may occur via an API layer, directly via a network without using an API (e.g., using network 192 and/or network 194 illustrated in the embodiment of FIG. 1), directly via a communication channel without using an API, and/or through any combination of an API, network and communication channel. For example, in various embodiments, communications through an API layer also traverses one or more networks (e.g., a WiFi network, a cellular network, etc.). Additional discussion of networks and communication channels is provided in connection with the embodiment of FIG. 2. As another example, in various embodiments, communications between an omnichannel layer, a data management and analytics layer and/or a data processing system in possession of a consumer may take place through any of the following: (a) directly via one or more networks and without going through any APIs (e.g., a mobile app running on a consumer phone may establish an encrypted connection to an omnichannel layer and conduct a commerce transaction by transmitting and receiving data without going through an API), (b) through an API, and (c) through a combination of one or more APIs and directly via one or more networks and without going through an API (e.g., some communications may be direct and without an API, and some communications may be routed via an API).

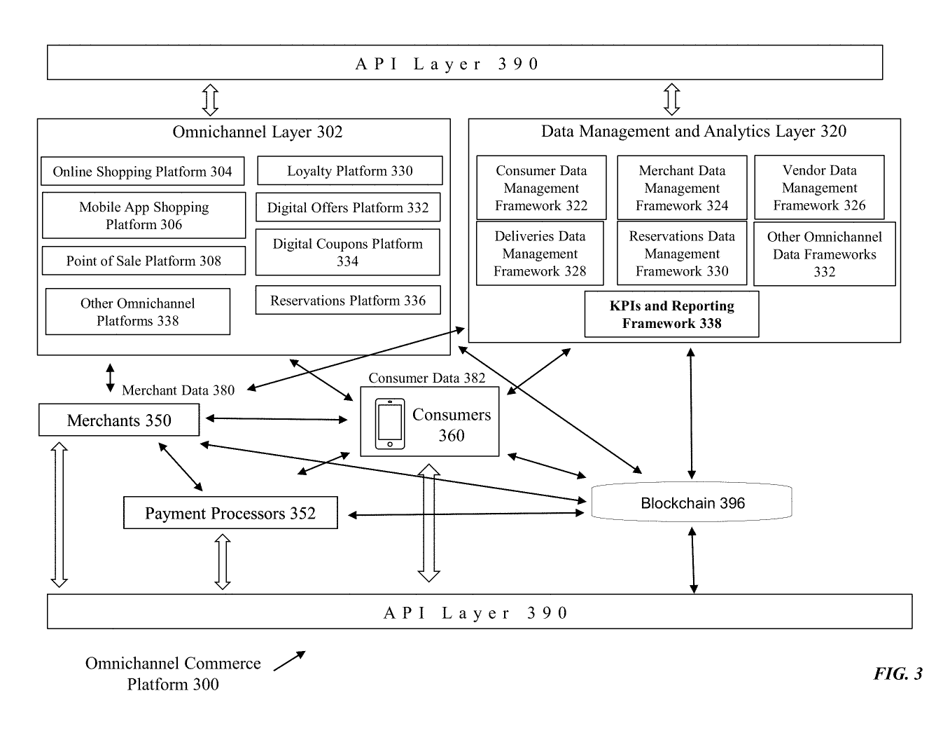

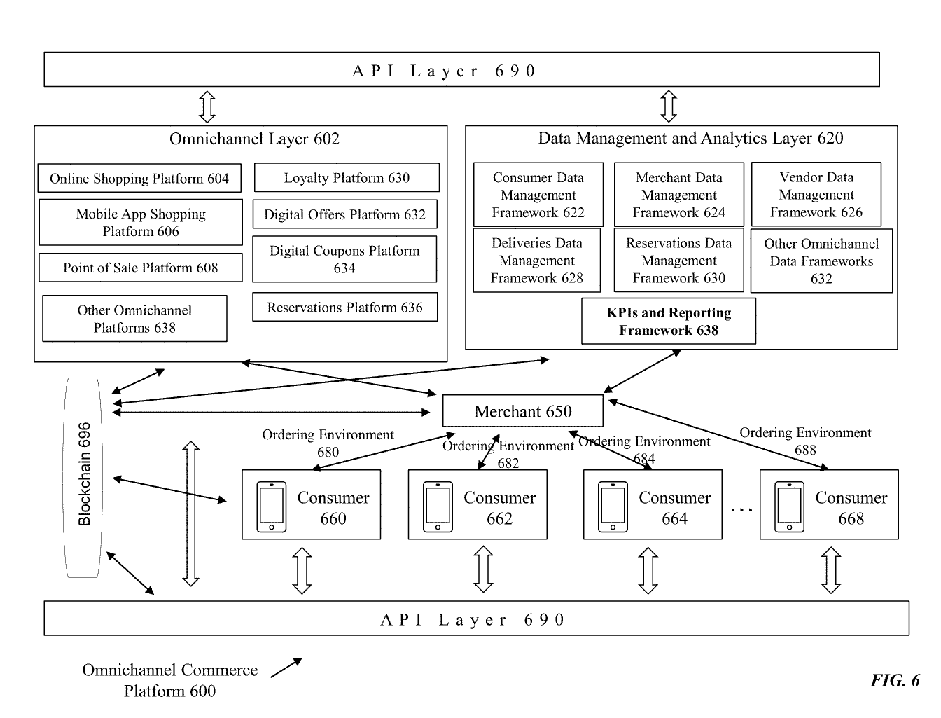

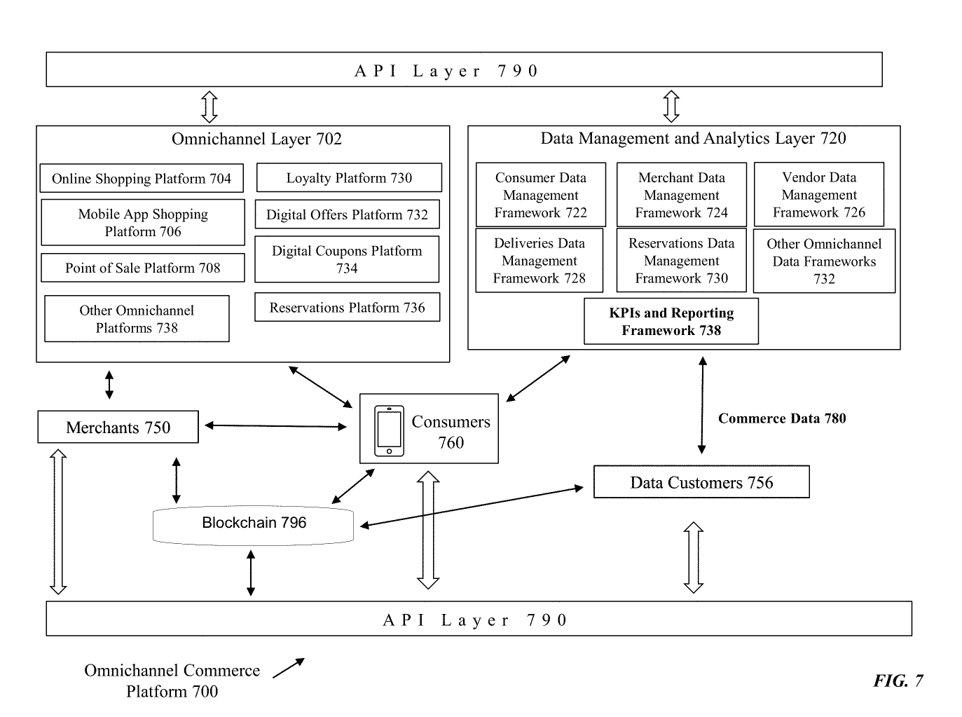

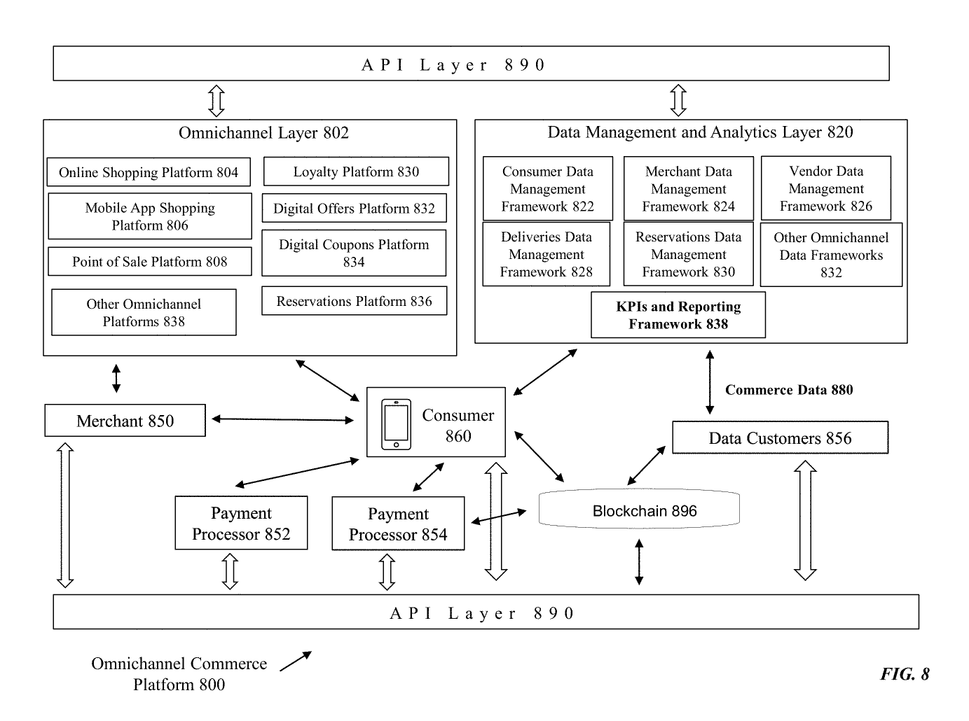

For example, in various embodiments, (a) an online shopping platform, a mobile app shopping platform, a loyalty platform, a digital offers platform, a digital coupons platform, a reservations platform, one or more other omnichannel platforms, a consumer data management framework, a merchant data management framework, a vendor data management framework, a deliveries data management framework, a reservations data management framework, one or more other omnichannel data frameworks, a KPI and reporting framework, one or more data processing systems in possession of one or more consumers, one or more merchants (e.g., one or more data processing systems in possession or under the control of a merchant, a cloud portal associated with a merchant, etc.), one or more payment processors, one or more data customers, one or more other commerce service providers, and any combination of the foregoing, (b) may directly or indirectly communicate with each other and/or with any other data processing system, API or network, (c) (i) through an API, (ii) directly via one or more networks and without using any APIs (e.g., a mobile app running on a consumer phone may establish an encrypted connection to an omnichannel layer and conduct a commerce transaction by transmitting and receiving data without going through an API), or (iii) through a combination of one or more APIs, and directly via one or more networks and without using an API. Examples of such platforms and frameworks are shown in the embodiments of FIG. 1, FIG. 3, FIG. 6, FIG. 7 and FIG. 8.

In various embodiments, a merchant 150 may be classified as a micro merchant (e.g., a merchant that has a small volume of sales), a mobile merchant (e.g., a merchant operating a food truck, mobile kiosk, or other mobile commercial facility), a small or medium business (SMB), or an enterprise merchant. A larger SMB may operate a single location with a high volume of transaction or sales, or multiple locations with a wide range of transaction or sales volumes. An enterprise merchant will typically operate tens, hundreds, thousands or even more locations, with a wide range of transaction or sales volumes. Enterprises and larger SMBs may operate in more than one country. Sometimes depending on classifications and conventions used, larger SMBs may overlap with smaller enterprises in terms of number of locations or volumes of transactions or sales. In general, a merchant with more than 50 locations may be considered by convention to be an enterprise merchant, but the distinction may be fuzzy and may not need to be made fully in such cases. Merchants that are usually classified as enterprises include large department store operators (e.g., Macy's, Walmart, Target), large gas station operators (e.g., Chevron, ExxonMobil, Shell), large fast food chains or franchises (e.g., McDonald's), and so on.

For convenience, to facilitate the legibility of the figure, the API layer 190 is shown twice in FIG. 1; in various embodiments, the API layer 190 may be, or may include one or more APIs that perform various functions within the omnichannel commerce platform 100. For example, in various implementations, one or more APIs included in the API layer 190 may connect one or more of the platforms included in the omnichannel layer 102 (e.g., connecting one or more of the online shopping platform 104, mobile app shopping platform 106, point of sale platform 108, loyalty platform 110, digital offers platform 112, digital coupons platform 114, reservations platform 116, and or one or more of the other omnichannel platforms 118). As another example, in various implementations, one or more APIs included in the API layer 190 may connect one or more of the frameworks included in the data management and analytics layer 120 (i.e., connecting one or more of the consumer data management framework 122, merchant data management framework 124, vendor data management framework 126, deliveries data management framework 128, reservations data management framework 130, one or more of the other omnichannel data frameworks 132, and/or the KPIs and reporting framework 138). As another example, in various implementations, one or more APIs included in the API layer 190 may connect one or more of the frameworks included in the data management and analytics layer 120 with one or more of the platforms included in the omnichannel layer 102. As another example, in various implementations, one or more APIs included in the API layer 190 may connect one or more of the frameworks included in the data management and analytics layer 120, one or more of the platforms included in the omnichannel layer 102, one or more of the consumers 160, one or more of the merchants 150, one or more of the merchants 152, one or more of the data customers 156, and/or one or more of the other commerce service providers 158.

In various embodiments, the data received, transmitted and/or processed by one or more of the frameworks included in the data management and analytics layer 120, one or more of the platforms included in the omnichannel layer 102, one or more of the consumers 160, one or more of the merchants 150, one or more of the payment processors 152, one or more of the data customers 156, and/or one or more of the other commerce service providers 158 is or includes commerce data.

In various embodiments, commerce data refers to data that is used to initiate, conduct, process, facilitate, analyze and/or otherwise manage commerce transactions, data that is produced in the course of commerce transactions, and/or data that is otherwise produced based on commerce transactions. In various embodiments, commerce data may include consumer data, merchant data, vendor data, deliveries data, reservations data, cryptocurrency data, cryptographic token data, other omnichannel data and/or KPIs based on any of the foregoing. In various embodiments, commerce data may be, or may include, raw data (e.g., SKU-level data, transaction data (e.g., prices and number of items purchased, etc.), Cardholder Data (e.g., as defined by PCI DSS Standards), and other such specific data), and/or aggregated and anonymized data (e.g., total Dollar volume of purchases, total number of specific items (e.g., Diet Coke) purchased, average check amount for restaurant guests, shopping habits of consumers in a zip code, etc.).

In various embodiments, commerce data may include data relating to commerce transactions. In some embodiments, a commerce transaction that involves a consumer and a merchant may generate commerce transaction that can be characterized as both merchant data and consumer data. Such merchant data and consumer data originating from commerce transactions may include information relating to the sale, purchase or leasing of products or services, including in various embodiments the sale of an electronic device or peripheral in a store or via a mobile app or online, purchasing fuel (e.g., gasoline, Diesel, or another type of fuel suitable for a vehicle) and/or other items from a gas station and/or associated retail store), sale of groceries in a grocery store, a hotel or other lodging transaction (e.g., renting a room, checking into a room, checking out of a room, ordering room service, or making a reservation for a facility within a hotel), a reservation for a restaurant, the payment for a meal in a restaurant, the rental of a car, the purchase of a ticket for travel (e.g., a ticket for a plane, bus, subway, train or other form of transportation), a ticket for an event (e.g., a ticket for a sports, concert or conference event), a reservation and payment for, and the delivery of a service provided by a Governmental agency such as a Department of Motor Vehicles, a bank transaction (e.g., receiving or depositing funds, concluding a loan, or receiving financial advice from a financial professional or other bank representative), the purchase of items or services online or via a mobile phone app, and/or any other transaction that involves a payment for, purchase of, sale of, delivery of, and/or receiving of a product or service. Such merchant data and consumer data originating from commerce transactions may also include cryptocurrency data and/or cryptographic token data.

Other examples of consumer data and/or merchant data may include in various embodiments data about a consumer involved in a commerce transaction (including personal data or personally identifiable information (PII)), Cardholder Data or other information about the payment method used for that commerce transaction, information regarding the product or service that was purchased, sold or received in the transaction, information regarding the merchant that provided or facilitated that transaction, information regarding any entity involved in the delivery of processing of the transaction (e.g., food or product delivery company), information about the product or service that was purchased or delivered as part of the transaction, and so on.

In various embodiments, examples of personal data or PII of a consumer may include name, physical address, email address, identification number (e.g., Driver License, passport number, or other uniquely identifiable document or ID number), IP address if associated with the consumer, vehicle registration plate number, face, fingerprints, handwriting, Cardholder Data, cryptocurrency data, cryptographic token data, date of birth, birthplace, genetic information, telephone number, login name, personally identifiable screen name, personally identifiable nickname, or other personally identifiable data that can identity the consumer among a larger number of individuals. Examples of cryptocurrency data that may be personal data (or PII) or cryptographic token data that may be personal data (or PII) include information identifying a cryptocurrency wallet of a consumer (e.g., a software program that stores private and public keys and interacts with one or more blockchains to enable users to send and receive digital currency and monitor their balances), usernames, passwords, encryption keys, and so on.

In various embodiments, examples of Cardholder Data may include with respect to a payment card or other method of payment (e.g., credit card, ATM card, debit card, etc.) a Primary Account Number (i.e., a payment card number that identifies the card issuer and the particular cardholder account), a Card Verification Code (Card Security Code), a cardholder name, an expiration date and/or service code, and/or Sensitive Authentication Data (e.g., security-related information, card validation codes or values, full track data from a magnetic stripe or from a chip, a pin number), and other such types of information (e.g., as defined by PCI DSS Standards or in other legislation or regulations).

Other examples of consumer data and/or merchant data may include in various embodiments with respect to a product or service a name, description, SKU number (Stock keeping unit number), price, quantity, attribute (e.g., the color “red” or size “large” of a shirt), ingredients or recipe of a food item in a restaurant, a delivery date and/or expiration date of a perishable item, a source or vendor identifier for an item, and so on.

Other examples of merchant data may include in various embodiments with respect to a merchant that sells or provides a product or service a name, location, address, menu, existing inventory, predicted inventory needs, historical sales records and inventory levels, operating hours, availability of delivery services, availability of merchandize pickup services, availability of an online ordering or purchase platform, availability of a mobile app ordering or purchase platform, availability of an digital menu or retail catalog accessible via an online or mobile app platform, and so on. With respect to a consumer that conducted one or more commerce transactions from a merchant, such data could also be considered consumer data in various embodiments.

Examples of merchant data and/or vendor data in various embodiments may include information about a vendor that delivers products or ingredients to a merchant, a record of the vendor's and/or merchant's historical, current or predicted inventory of products and/or ingredients, a delivery radius, a price, a volume of merchandise availability, a product or service marker of a food item, a price of a food item, an identification marker of a beverage item, a price of a beverage item, a price of a meal, a price of an item being sold, an identification marker of an item being sold, or any other characteristic or attribute of any item that is the subject of a POS transaction and that is commonly used to identify and/or process that item.

Other examples of consumer data and/or merchant data may include in various embodiments, the identity or SKU number of a product or service purchased or leased, a transaction ID number, Cardholder Data or other payment information (e.g., a credit card number, a payment approval token, identification of a customer conducting a Point of Sale transaction), PII or other information relating to a consumer involved in the transaction, information about a merchant involved in the transaction (e.g., name, location and address of the merchant), the date and time of the transaction, other products or services purchased in that transaction or in other transactions related to that transaction, a commerce platform used to conduct or facilitate the transaction (e.g., a mobile app shopping platform or online shopping platform used to initiate or complete a purchase), and so on.

In various embodiments, vendor data, such as data processed by a vendor data management framework (illustrated in the embodiment of FIG. 1 by the vendor data management framework 126), may include data relating to one or more vendors that manufacture, distribute and/or deliver food, merchandise and/or services to merchants, data about one or more supply chains, and other data about companies, manufacturing facilities, distribution facilities, transportation, logistics, delivery times, manufacturing or supply lead times, information about imbalances in supply and demand within a supply chain or as applicable to one or more merchants or vendors, and any trends, statistics, predictions, historical information, KPIs and other past, current or predicted metrics relating to any of the foregoing.

In accordance with various embodiments, a data management and analytics layer, such as the data management and analytics layer 120 illustrated in FIG. 1, may receive and process data relating to merchants, consumers, vendors, deliveries, reservations, and other omnichannel areas of the commerce chain, and visibility into such data types may enable the data management and analytics layer to identify and predict trends in consumer behavior, merchant sales, merchant inventory needs, optimal vendor supply ordering and allocation, transportation and logistics resource allocation, and so on. For example, in various embodiments, the data management and analytics layer receives merchant data and/or consumer data relating to real-time transactions or searches by consumers for food items, merchandise and/or services conducted through an online shopping platform or mobile app shopping platform, and based on such merchant data and/or consumer data, the data management and analytics layer may predict consumer behavior, merchant sales and merchant inventory needs, which then in turn could be used to generate and/or augment vendor data, which it can then use to optimize vendor supply ordering and allocation, transportation and logistics resource allocation, and other aspects of the supply chain.

In one embodiment, a consumer 160 uses a mobile phone to access the omnichannel layer 102 in the embodiment of FIG. 1 to make a purchase from a merchant 150 via the mobile app shopping platform 106 associated with that merchant. In this embodiment, the respective commerce transaction is processed using commerce data received from the data management and analytics layer 120 via the API layer 190 (e.g., retrieving information about a loyalty account associated with the consumer 160 from the consumer data management framework 122 and/or from a loyalty data framework that may be included in the other omnichannel data framework 132). In various embodiments, once the commerce transaction is completed and/or during the processing of the transaction, an updated set of commerce data is transmitted to the data management and analytics layer 120, where information regarding the commerce transaction is updated in the consumer data management framework 122, in the merchant data management framework 124, and possibly in a loyalty data framework that may be included in the other omnichannel data framework 132. As illustrated in this example, the omnichannel commerce platform 100 has the ability in various embodiments to facilitate sales by merchants using commerce data, while further refining the commerce data in its databases.

In various embodiments, one or more of the platforms included in the omnichannel layer 102 and one or more of the frameworks included in the data management and analytics layer 120 may be switched or consolidated, and may further incorporate additional functionality. For example, in one embodiment, the online shopping platform 104 may also include some or all of the consumer data management framework 122 and/or merchant data management framework 124. As another example, in one embodiment, the mobile app shopping platform 106 may also include some or all of the consumer data management framework 122 and merchant data management framework 124, and may further include payment processing functionality that would allow a data processing system in possession of the consumer (e.g., a mobile phone running an app) to conduct a purchase of a food item, retail item and/or service from a merchant using consumer data, merchant data, and an integrated payment function for charging a credit card of the consumer.

In various embodiments, an omnichannel commerce platform may manage an app running on a data processing system in possession of a consumer (e.g., on a mobile phone, on a wearable device, on a display in a vehicle in which the consumer is the driver or a passenger, etc.). For example, in various embodiments, the omnichannel commerce platform may receive real time data or buffered data from an app running on a data processing system in possession of a consumer, positional location, a request for an ordering environment of a merchant (e.g., a menu of a restaurant), a request to complete a credit card or crypto-currency payment initiated by the consumer, etc. As another example, in various embodiments, the omnichannel commerce platform may transmit to an app running on a data processing system in possession of a consumer a customized ordering environment for a merchant (e.g., a retail shopping product and ordering list), a confirmation for a credit card or crypto-currency payment initiated by the consumer, digital content purchased by the consumer (e.g., a song or movie ordered by the consumer), etc. In various embodiments, an app running on a data processing system in possession of a consumer may be considered part of the omnichannel commerce platform.

In various embodiments, one or more networks, such as network 192 and network 194 shown in the embodiment of FIG. 1, provide communication functionality to one or more of the following: the online shopping platform 104, mobile app shopping platform 106, point of sale platform 108, loyalty platform 110, digital offers platform 112, digital coupons platform 118, reservations platform 116, other omnichannel platforms 118, consumer data management framework 122, merchant data management framework 124, vendor data management framework 126, deliveries data management framework 128, reservations data management framework 130, other omnichannel data frameworks 132, KPIs and reporting framework 138, omnichannel layer 102, data management and analytics layer 120, one or more merchants 150, one or more payment processors 152, one or more data customers 156, one or more consumers 160, one or more other commerce service providers 158, and/or to any combination of the foregoing.

In various embodiments, a blockchain 196 provides blockchain functionality to the omnichannel commerce platform 100 of the embodiment of FIG. 1. In FIG. 1, the blockchain 196 is shown twice for convenience, but in various embodiments, the blockchain 196 may represent a single blockchain (or blockchain network). In various embodiments, the blockchain 196 may represent two or more blockchains (or blockchain networks) that provide the same, similar, complementary or different functionality to an omnichannel commerce platform, such as the omnichannel commerce platform 100 of the embodiment of FIG. 1.

A blockchain (sometimes denoted as a blockchain network) is a list of records, called blocks, which are linked and secured using cryptography. A blockchain has certain attributes of a relational database. Individual blocks may include a cryptographic hash pointer as a link to a previous block, a timestamp, and transaction data. Blockchains are typically resistant to modification of the data. In various implementations, a blockchain may act as an open, distributed ledger that can record transactions between parties in a verifiable and resilient manner. A blockchain may be managed by a peer-to-peer network collectively adhering to a protocol for validating new blocks. In various implementations, data in particular blocks cannot be altered retroactively without the alteration of one or more other blocks, which provides an inherent resilience to undesirable record modifications. In various implementations, blockchains can achieve a high level of protection against unauthorized modifications of data, which could provide a mechanism suitable for authorizing and storing commerce transactions, and recording of commerce data.

In various implementations, a blockchain can also provide a framework for processing and tracking smart contracts. A smart contract is a computer protocol or algorithm adapted to facilitate, verify, or enforce the negotiation or performance of a contract or understanding between two or more parties. Smart contracts may facilitate the processing and completion of transactions between two or more parties using a decentralized approach, without a specific pre-designated decisionmaker. Smart contract transactions may be trackable and resistant to unauthorized modifications.

Blockchains also facilitate the deployment of cryptocurrencies (also denoted as “crypto coins” or “coins”) and cryptographic tokens (also denoted as “crypto-tokens” or “tokens”), and the usage of such cryptocurrencies and crypto-tokens as currency or consideration for various transactions, including as consideration for smart contracts. Examples of cryptocurrencies include Bitcoin, Litecoin, Namecoin and Ethereum.

In various implementations, a particular blockchain may be adapted to run smart contracts using one or more cryptocurrencies or cryptographic tokens. For example, the Ethereum blockchain can run smart contracts (e.g., using an Ethereum virtual machine) and using a cryptocurrency (e.g., the Ethereum cryptocurrency).

In various embodiments, a statement that a blockchain “runs” a smart contract, or a statement that a smart contract “runs” on a blockchain, means that a blockchain is adapted to facilitate the operation of a smart contract by running the code that implements the rules of the smart contract. In one embodiment, a blockchain could be construed as a distributed computing network where a set of points, links or nodes in the network can run a portion or all of the code that implements a one, more or all of the rules of a smart contract. In various embodiments, a smart contract could run on more than one blockchain, where one or more rules of the smart contract could run on one or more blockchains.

In various embodiments, a smart contract could be divided into a set of operational blocks. In various embodiments, each operational block could be a rule, a set of two or more rules, a portion of a rule, or any combination of the foregoing.

In various embodiments, two or more of the code blocks could run on different blockchains (e.g., in parallel, serially, or as a combination of parallel and serial execution). For example, this could increase the speed or reliability of operation by using the computing power of more than one blockchain to run a single smart contract. The various code blocks could then be reassembled to check that execution state of the smart contract.

In various embodiments, a particular code block could run on two or more blockchains. For example, this could increase the speed of operation by selecting the first code block returned by the various blockchains. As another example, this could increase the security or reliability by checking the results of the two or more code blocks received from various blockchains and selecting a version of the code block that satisfies certain criteria (e.g., less likely to have been tempered or more likely to be accurate). The various code blocks could then be reassembled to check that execution state of the smart contract.

In one implementation, a cryptocurrency or cryptographic token may be deployed on a single blockchain. Reasons why this may be desirable in various cases include better security by limiting operation to a single blockchain, better integration with smart contracts running on the same blockchain, desire to create a closed ecosystem around a single blockchain, and so on.

In various implementations, a cryptocurrency or cryptographic token may be deployed on two or more blockchains. This may be achieved, for example, by splitting a cryptocurrency or cryptographic token into multiple versions with each version running on a single blockchain, or by adapting a single cryptocurrency to run on multiple blockchains. Reasons why this may be desirable in various cases include broader distribution of the cryptocurrency, mitigating the risk that any particular blockchain could be compromised in terms of security, reliability or speed, and so on.

A cryptocurrency (or cryptographic coin) may be defined as a digital asset designed to work as a medium of exchange that uses cryptography to secure transactions, to control the creation of additional units, and to verify the transfer of assets.

A cryptographic token may also be defined as a digital asset. In one embodiment, a token may be a cryptocurrency. In one embodiment, a token may represent a combination of cryptocurrencies, possibly weighted (e.g., a basket of cryptocurrencies). In one embodiment, a token may represent a classic currency (e.g., United States Dollars). In one embodiment, a token may represent a combination of classic currencies, possibly weighted (e.g., a basket of classic currencies). In one embodiment, a token may represent a combination of cryptocurrencies and classic currencies, possibly weighted.

In one embodiment, a token may represent the value of an underlying asset (sometimes denoted a “token asset”). An example of a token asset is loyalty points or loyalty units issued by a commercial establishment or in connection with a commercial transaction (e.g., a purchase from a food establishment or from a retail store). Another example of a token asset is a currency unit that can be used inside a game or online environment to purchase assets offered in such game or online environment. Another example of a token asset is a representation of underlying asset value, such as shares in a corporation, equities or securities, a valuation of a future contract value, or an expected value of a future benefit.

In various embodiments, a cryptographic token may represent a mechanism for converting between, or for buying and selling various commercial attributes of a commercial platform, such as loyalty units (or loyalty points), data, data analytics (including various Key Performance Indicators (KPIs)), or other assets available in such platform. In one embodiment, an end consumer may use a cryptographic token to purchase goods or services from one or more merchants using a data processing system, such as a mobile phone.

In various embodiments, a cryptographic token or cryptocurrency may represent a mechanism for purchasing products or services (e.g., the token or currency may serve the function of a classic currency that permits a consumer to pay for a product or service).

For example, in the embodiment of the FIG. 1, the omnichannel commerce platform 100 may present to a consumer 160 a price for a food item or for a product available from a merchant 150 denominated in either a cryptocurrency or in a cryptographic token.

In one embodiment, a consumer 160 uses a mobile phone to access the omnichannel layer 102 in the embodiment of FIG. 1 to make a purchase from a merchant 150 via the mobile app shopping platform 106 associated with that merchant, and pays for such purchase using a cryptocurrency or a cryptographic token. In one embodiment, the respective commerce transaction is processed using commerce data received from the data management and analytics layer 120 via the API layer 190, and such commerce data may include cryptocurrency data and/or cryptographic token data.

In various embodiments, commerce data used, processed, updated, managed and/or stored by or through an omnichannel commerce platform, such as the omnichannel commerce platform 100 of FIG. 1, includes cryptocurrency data and/or cryptographic token data. In various embodiments, cryptocurrency data and/or cryptographic token data may include data that is used to initiate, conduct, process, facilitate, analyze and/or otherwise manage commerce transactions, data that is produced in the course of commerce transactions, and/or data that is otherwise produced based on commerce transactions. In various embodiments, cryptocurrency data and/or cryptographic token data may include consumer data, merchant data, vendor data, deliveries data, reservations data, other omnichannel data and/or KPIs based on any of the foregoing. In various embodiments, cryptocurrency data and/or cryptographic token data may include a price denominated in a cryptocurrency, a price denominated in a cryptographic token, a balance of loyalty credits available to that consumer denominated in a cryptocurrency and/or in a cryptographic token, a loyalty balance that would be credited to the consumer for completing that transaction where such balance is denominated in a cryptocurrency and/or in a cryptographic token, a digital wallet identifier, a consumer identity identifier (e.g. username or password), a point of sale identifier (e.g., the identity of a point of sale system that processed a transaction), a blockchain identifier, a loyalty account identifier, a digital coupon identifier, a digital coupon amount, a digital offer amount, a discount amount, one or more conditions associated with a digital coupon (e.g., a smart contract that determines when the digital coupon could be applied and to what extent, whether in whole or in part), one or more conditions associated with a digital offer (e.g., a smart contract that determines when the digital offer could be applied and to what extent, whether in whole or in part), one or more conditions associated with a discount (e.g., a smart contract that determines when the discount could be applied and to what extent, whether in whole or in part), information about a smart contract that relates to a commerce transaction, or any combination of the foregoing.

In various embodiments, commerce data that includes cryptocurrency data and/or cryptographic token data is received from the omnichannel layer 102, from the data management layer 120, from the network 192, from the API layer 190, from the blockchain 196 (or from two or more blockchains illustrated by the blockchain 196), from one or more merchants 150, from one or more payment processors 152, from one or more data customers 156, from one or more consumers 160, from one or more other commerce service providers 158, from the online shopping platform 104, from the loyalty platform 130, from the mobile app shopping platform 106, from the digital offers platform 132, from the point of sale platform 108, from the digital coupons platform 134, from the other omnichannel platform 138, from the reservations platform 136, the consumer data management framework 122, from the merchant data management framework 124, from the vendor data management framework 126, from the deliveries data management framework 128, from the reservation data management framework 130, from the other omnichannel data frameworks 132, from the KPIs and reporting framework 138, and/or from any combination of the foregoing.

In various embodiments, once the commerce transaction involving a consumer 160 is completed and/or during the processing of the transaction, an updated set of commerce data that includes cryptocurrency data and/or cryptographic token data is transmitted to the omnichannel layer 102, to the data management layer 120, to the network 192, to the API layer 190, to the blockchain 196 (or to two or more blockchains illustrated by the blockchain 196), to one or more merchants 150, to one or more payment processors 152, to one or more data customers 156, to one or more consumers 160, to one or more other commerce service providers 158, to the online shopping platform 104, to the loyalty platform 130, to the mobile app shopping platform 106, to the digital offers platform 132, to the point of sale platform 108, to the digital coupons platform 134, to the other omnichannel platform 138, to the reservations platform 136, to the consumer data management framework 122, to the merchant data management framework 124, to the vendor data management framework 126, to the deliveries data management framework 128, to the reservation data management framework 130, to the other omnichannel data frameworks 132, to the KPIs and reporting framework 138, and/or to any combination of the foregoing.

In one embodiment, a consumer 160 is incentivized to allow the omnichannel commerce platform 100 to collect data regarding the consumer (e.g., via a mobile phone or other data processing system used by the consumer) by paying such consumer using a cryptocurrency and/or a cryptographic token. Such data that may be collected in exchange for cryptocurrency and/or cryptographic tokens may include consumer behavioral data, information about the consumer's shopping preferences information about the consumer's shopping transactions, information about the consumer's payment methods, information about the consumer's usage of loyalty points, information about the consumer's usage of digital offers, information about the consumer's usage of discounts, information about the consumer's usage of smart contracts, information about the consumer's usage of cryptocurrencies, information about the consumer's usage of classic currencies, information about the consumer's usage of cryptographic tokens, information about the consumer's responses to various graphical user interface aspects of a data processing system (e.g., which buttons or colors presented to the consumer via a mobile app or web browser tend to trigger certain consumer actions), information about the consumer's trips, information about the consumer's job or professional activities, information about the consumer's communication patterns (including phone, text, chat, or verbal communications), information about the consumer's mode of transportation, information about the consumer's connections, friends and relatives, information about the consumer's travel patterns, information about the consumer's web surfing activities, information about the consumer's mobile app usage activities, and so on. In various embodiments, the amount of cryptocurrency and/or a cryptographic tokens paid to a consumer in exchange for data collected from such consumer may vary depending on the type of data collected, the time of the day, the physical location, whether the data is collected in substantially real time during a consumer transaction or later, whether the data is collected from transactions processed by the omnichannel platform 100 as opposed to being extracted from other actions or transactions of that consumer, the type of data processing system from which the data is collected, and so on. In various embodiments, a consumer's account may be credited with cryptocurrency units and/or cryptographic tokens when commerce data relating to that consumer is collected from the consumer or from a third party, when a purchase transaction involving that consumer is completed, at a later predetermined or random time, at regular intervals, in response to smart contracts or other rules, when data relating to that consumer is monetized (e.g., when another entity purchases commerce data, data analytics or KPIs that include that consumer's data), and/or at other times. In various embodiments, some types of consumer data collected from a consumer may include a higher degree of confidential content, privacy concern, or consumer sensitivity, in which case such data may be purchased from the consumer for a higher price, or such data may be omitted from the collection (e.g., omitted sometimes depending on certain rules, or never collected).

In various embodiments, if particular consumer data is available from more than one source in whole or in part, the price paid for the data to one or more of the sources may be lower. For example, if the omnichannel commerce platform can collect data about a particular consumer transaction involving a consumer 160, a merchant 150 and a payment processor 152 from all three sources, the omnichannel commerce platform 100 may dynamically increase the price paid to the data consumer 160 in crypto tokens and may pay less (or may pay nothing) to the merchant 152 and/or the payment processor 152 for that transaction.

In various embodiments, a single shopping transaction may involve the purchase and sale of goods or services and the purchase and sale of data. For example, in a consumer transaction involving a consumer 160 and a merchant 150, the consumer may purchase a food item from the merchant, and the merchant may sell that item to the consumer. As part of that transaction, a delivery to the consumer may occur, in which case a delivery company may also receive certain payment for the delivery of the food item. The omnichannel commerce platform may purchase consumer data relating to that transaction from the consumer, merchant and/or delivery company, and may sell at least a portion of that data (whether alone or in combination with other commerce data) to a payment processor and/or to another data customer. The account of the consumer may be credited and/or debited as part of a loyalty program. A digital offer, coupon or discount made available by the merchant may be used in whole or in part. Some or all of these transactions involving the purchase and selling of goods, services and/or data may involve payments, credits and/or debits using one or more cryptocurrencies, one or more types of cryptographic tokens, and/or one or more types of classic currencies. One or more smart contracts may determine various aspects of such purchase and selling of goods, services and/or data (e.g., dynamic variations in the price of the goods, services or data, the seller and/or buyer of such goods, services and/or data, the timing when various such aspects of the transaction are completed, and so on).

In one embodiment, a cryptocurrency is used to convert a classic currency into a different classic currency. For example, a consumer 160 normally residing in the United States may be traveling in a European country, and may purchase a good or service from a merchant located in that European country. The consumer may be familiar primarily with US Dollars and the merchant may price its goods and/or services in Euros, which could interfere with the efficient completion of this transaction. In one embodiment, the omnichannel commerce platform 100 may take the merchant's price in the local currency (e.g., Euros), may convert it into a cryptocurrency or cryptographic token known to the omnichannel commerce platform 100, may then convert the resulting price into a currency familiar to the consumer (e.g., US Dollars), and may present the value to the consumer in the familiar currency, in a cryptocurrency denomination, and/or in a cryptographic token denomination. If the consumer completes the transaction, the omnichannel commerce platform 100 may automatically convert the purchase price paid by the consumer into the currency desired by the merchant (e.g., Euros) and may transfer the corresponding amount to the merchant's account. Such a transaction may result in certain transaction fees charged to the merchant's account and/or paid by the consumer, which could accordingly be charged to the consumer in addition to the net purchase price and/or may be deducted from the merchant's net selling price. Consequently, in various embodiments, an omnichannel commerce platform may dynamically process a price for goods or services presented in a classic currency, may convert such price into one or more intermediate cryptocurrencies or cryptographic tokens, and may present such price to one or more consumers in a different classic currency, in a cryptocurrency, or in a cryptographic token denomination.

In various embodiments, an omnichannel commerce platform, such as the omnichannel platform 100 from the embodiment of FIG. 1, may enable a consumer 160 to transfer funds to a different consumer 160 or to a business using an intermediate conversion into a set of cryptocurrencies and/or cryptographic tokens. In one embodiment, a consumer 160 may transfer funds using a data processing system (e.g., a mobile app running on a mobile phone) to a different consumer 160 who also uses a data processing system (e.g., a mobile app running on a mobile phone). In one embodiment, the omnichannel commerce platform 100 may take the amount sent by the sender consumer in the local currency (e.g., Euros), may convert it into a cryptocurrency or cryptographic token known to the omnichannel commerce platform 100, may then convert the resulting amount into a currency familiar to the recipient consumer (e.g., US Dollars), and may present the value to the recipient consumer in the familiar currency, in a cryptocurrency denomination, and/or in a cryptographic token denomination. If the fund transfer transaction is completed, the omnichannel commerce platform 100 may automatically convert the amount transferred by the sender consumer into the currency desired by the recipient consumer (e.g., US Dollars) and may transfer the corresponding amount to the recipient consumer's account. Such a transaction may result in certain transaction fees charged to the recipient's account and/or paid by the sender, which could accordingly be charged to the sender in addition to the net amount sent and/or may be deducted from the recipient's net proceeds received. Consequently, in various embodiments, an omnichannel commerce platform may dynamically process an amount sent in a classic currency, may convert such amount into one or more intermediate cryptocurrencies or cryptographic tokens, and may present such amount to a recipient in a different classic currency, in a cryptocurrency, or in a cryptographic token denomination.

In various embodiments, a consumer 160 is incentivized by the omnichannel commerce platform 100 to perform one or more activities (e.g., via a mobile phone or other data processing system used by the consumer) by paying such consumer using a cryptocurrency and/or a cryptographic token. Such consumer activities may be rewarded with varying amounts of cryptocurrency and/or cryptographic tokens, depending on the type of action performed by the consumer and depending on the context of the action. In various embodiments, such consumer activities may include purchasing a product or service (or a combination of products and/or services), entering a particular business establishment, making a purchase from a particular business establishment, reviewing a particular product or service, reviewing a particular merchant, expressing a preference or dislike for a particular product or service (e.g., a food item, a retail article, a delivery service, a loyalty program, a cryptocurrency, a cryptographic token, etc.), expressing a preference or dislike for a particular commercial establishment (e.g., for a particular restaurant, restaurant chain, or specific location of a restaurant chain), expressing a preference or dislike for a class of business establishments, (e.g., pizzerias, a particular type of retail store, etc.), altering a trip (e.g., exiting a freeway or public transportation to shop at a particular commercial establishment, changing a travel route, etc.), altering a walking direction, using a particular payment method to make a payment or transfer funds (e.g., choosing to pay using a credit card, cryptocurrency, cryptographic token, cash, or some other form of payment), using a particular payment instrument to make a payment or transfer funds (e.g., choosing a particular credit card, such as a “Wells Fargo” credit card, a VISA credit card, a MasterCard ATM card, etc.), using a particular electronic wallet to make a payment or transfer funds (e.g., an electronic wallet issued by Apple or Google, an electronic wallet holding a cryptocurrency and/or cryptographic token, etc.), using a particular payment method, payment instrument, or electronic wallet to receive a payment or funds transferred by another party, redeeming a loyalty credit as part of a transaction (e.g., redeeming loyalty points, redeeming a cryptocurrency representing loyalty credit, redeeming a cryptographic token representing loyalty credit, etc.), communicating with a particular individual or group (e.g., via text, email, social network, bulletin board, etc.), voting or withholding a vote (to the extent permitted by applicable laws, regulations and contracts), granting a voting proxy, engaging in a certain commercial transaction (e.g., selling an good or service, transferring or receiving an asset, transferring or receiving a benefit or another item with a present or future expected commercial value), granting a consent (e.g., consenting to the collection of certain personal data (PII) or other data about the consumer via a mobile app, website or via another data processing system), and so on.

In various embodiments, the amount of cryptocurrency and/or cryptographic tokens paid to a consumer to incentivize or reward the consumer for performing a specific activity may vary depending on the context of the activity. Examples of such contexts include the time of the day when the activity takes place, the physical location, whether the activity takes place in substantially real time during a consumer transaction or later, whether the activity takes place in connection with transactions processed by the omnichannel platform 100 as opposed to other actions or transactions of that consumer, the type of data processing system involved in the consumer's activity, and so on. In various embodiments, a consumer's account may be credited in full or in part with corresponding cryptocurrency units and/or cryptographic tokens when the consumer initiates the activity, while the consumer performs the activity, after the consumer completes the activity, at a later predetermined or random time, at regular intervals, in response to smart contracts or other rules relating to such activity, when data resulting from that activity is monetized (e.g., when another entity purchases commerce data, data analytics or KPIs that include data generated by such activity), and/or at other times. In various embodiments, some activities performed by a consumer may include a higher degree of confidential content, privacy concerns, conduct that is clearly illegal or in violation of applicable civil or criminal rules or regulations, conduct that may be illegal or in violation of applicable civil or criminal rules or regulations, conduct that may potentially breach existing contractual obligations of the consumer or of another party, or other instances in which additional scrutiny of the activities may be necessary or desired, in which case such activities may be incentivized with a higher value, or such activities may be excluded in whole or in part from the scope of activities that are eligible to be incentivized.

In various embodiments, transactions between merchants, consumers, payment processors, data customers, other commerce service providers, and other parties may be conducted using one or more cryptocurrencies and/or one or more types of cryptographic tokens. In some embodiments, this may happen by preference, such as, for example, if a classic currency is experiencing high inflation, devaluation, or other undesirable characteristics, if exchange rates between classic currencies may fluctuate too much, or if one or more parties involved in an international transaction prefer to avoid conversions into various classic currencies. In some embodiments, this may happen because an operator of the omnichannel commerce platform (or an operator of a component included in the omnichannel commerce platform) requires the use of one or more cryptocurrencies and/or one or more types of cryptographic tokens for such transactions conducted through the omnichannel commerce platform, as opposed to the use of a classic currency. In some embodiments, this may happen because a particular party or set of parties (e.g., one or more merchants, consumers, payment processors, data customers, other commerce service providers, or other parties) may prefer or may require the use of one or more cryptocurrencies and/or one or more types of cryptographic tokens. In some embodiments, this may happen because the underlying costs of a transaction conducted through the omnichannel commerce platform may be lowered through the use of one or more cryptocurrencies and/or one or more types of cryptographic tokens as opposed to using a classic currency, a credit card, an ACH transfer, an ATM card, or some other payment method. In various embodiments, the decision of whether to use one or more cryptocurrencies and/or one or more types of cryptographic tokens for a particular transaction (e.g. the sale or purchase of a good or service, the redemption or grant of loyalty credits) or for a particular class of transactions (e.g., a set of transactions involving the purchase or sale of commerce data, a set of transactions involving the sale of goods or items by a particular merchant or by a set of merchants located in a particular geographic area) may be performed automatically by an omnichannel commerce platform (e.g., the omnichannel commerce platform 100 of FIG. 1) or by a component of the omnichannel commerce platform (e.g., by a mobile phone or other data processing system operated by a consumer, such as a consumer 160 from FIG. 1).

In various embodiments, a merchant may pay a certain fee, whether denominated in a classic currency, cryptocurrency and/or cryptographic tokens, to influence the way the merchant's products or services are presented to a consumer. For example, a merchant may pay (or may be charged by the omnichannel commerce platform), possibly using a smart contract or based on some other rules, to be ranked higher on the list of merchants presented to a consumer via a data processing system in possession of the consumer.

In various embodiments, a merchant receives a certain payment or credit, whether denominated in a classic currency, cryptocurrency and/or cryptographic tokens, based on how the merchant's products or services are presented to a consumer. For example, a merchant may be paid or credited a certain amount, possibly using a smart contract or based on some other rules, to be ranked lower on the list of merchants presented to a consumer via a data processing system in possession of the consumer, or to quote a lower price for a particular product, food item or service.

The amount of cryptocurrency and/or cryptographic tokens paid to a merchant to incentivize or reward the merchant, may vary depending on the context of the activity. Examples of such contexts include the time of the day when the activity takes place, the physical location, whether the activity takes place in substantially real time during a merchant transaction or later, whether the activity takes place in connection with transactions processed by the omnichannel platform 100 as opposed to other actions or transactions of that merchant, the type of data processing system involved in the respective merchant-consumer transaction, and so on. In various embodiments, a merchant's account may be credited in full or in part with corresponding cryptocurrency units and/or cryptographic tokens when a consumer initiates the activity, while a consumer performs the activity, after the consumer completes the activity, at a later predetermined or random time, at regular intervals, in response to smart contracts or other rules relating to such activity, when data resulting from that activity is monetized (e.g., when another entity purchases commerce data, data analytics or KPIs that include data generated by such activity), and/or at other times. In various embodiments, some activities performed by a merchant may include a higher degree of confidential content, privacy concerns, conduct that is clearly illegal or in violation of applicable civil or criminal rules or regulations, conduct that may be illegal or in violation of applicable civil or criminal rules or regulations, conduct that may potentially breach existing contractual obligations of the consumer or of another party, or other instances in which additional scrutiny of the activities may be necessary or desired, in which case such activities may be incentivized with a higher value, or such activities may be excluded in whole or in part from the scope of activities that are eligible to be incentivized. For example, a merchant may be paid a higher amount to share commerce data that includes personal data or payment-related data.

In various embodiments, because certain transactions conducted through an omnichannel commerce platform may be restricted to using one or more cryptocurrencies and/or one or more types of cryptographic tokens, demand for such cryptocurrencies and/or cryptographic tokens may increase, in which case the value of such cryptocurrencies and/or cryptographic tokens may increase relative to one or more classic currencies. Conversely, in various embodiments, if certain transactions conducted through an omnichannel commerce platform are prevented from using one or more cryptocurrencies and/or one or more types of cryptographic tokens, demand for such cryptocurrencies and/or cryptographic tokens may decrease, in which case the value of such cryptocurrencies and/or cryptographic tokens may decrease relative to one or more classic currencies. Fluctuation in the exchange rate between cryptocurrencies and/or cryptographic tokens may create the opportunity for currency trading or hedging, as traditionally done with classic currencies, and such trading or hedging could be automated in various embodiments through an omnichannel commerce platform, such as the omnichannel commerce platform 100 of FIG. 1. It is important for an operator of an omnichannel commerce platform, to the extent that the operator controls the deployment or trading of one or more cryptocurrencies and/or types of cryptographic tokens, to observe any applicable rules issued by relevant authorities.

In general, when the discussion in connection with various embodiments refers to an omnichannel commerce platform (such as the omnichannel commerce platform 100 of FIG. 1, omnichannel commerce platform 300 of FIG. 3, omnichannel commerce platform 600 of FIG. 6, omnichannel commerce platform 700 of FIG. 7, or omnichannel commerce platform 800 of FIG. 8) performing a function, taking an action, making a decision, enforcing a rule, facilitating a smart contract, or otherwise engaging or participating in an activity, the discussion is meant to also include the possibility that one or more components included in such omnichannel commerce platform may perform that function, take that action, make that decision, enforce that rule, facilitate that smart contract, or otherwise engage or participate in that activity, as appropriate in the context, unless otherwise expressly provided in that description.

For example, in various embodiments, when referring to a decision whether to conduct a particular transaction using one or more cryptocurrencies and/or types of cryptographic tokens, such decision may be made by the omnichannel commerce platform 100 itself, or by any of the following components (or any combination of the following components) that may be included in the omnichannel commerce platform: the omnichannel layer 102 or a set of data processing systems included therein, the data management layer 120 or a set of data processing systems included therein, the blockchain 196 (or to two or more blockchains illustrated by the blockchain 196) or a set of data processing systems included therein, one or more merchants 150 or a set of data processing systems associated with or operated by such one or more merchants, one or more payment processors 152 or a set of data processing systems associated with or operated by such one or more payment processors, one or more data customers 156 or a set of data processing systems associated with or operated by such one or more data customers, one or more consumers 160 or a set of data processing systems associated with or operated by such one or more consumers, one or more other commerce service providers 158 or a set of data processing systems associated with or operated by such one or more service providers, the online shopping platform 104 or a set of data processing systems included therein, the loyalty platform 130 or a set of data processing systems included therein, the mobile app shopping platform 106 or a set of data processing systems included therein, the digital offers platform 132 or a set of data processing systems included therein, the point of sale platform 108 or a set of data processing systems included therein, the digital coupons platform 134 or a set of data processing systems included therein, the other omnichannel platform 138 or a set of data processing systems included therein, the reservations platform 136 or a set of data processing systems included therein, the consumer data management framework 122 or a set of data processing systems included therein, the merchant data management framework 124 or a set of data processing systems included therein, the vendor data management framework 126 or a set of data processing systems included therein, the deliveries data management framework 128 or a set of data processing systems included therein, the reservation data management framework 130 or a set of data processing systems included therein, the other omnichannel data frameworks 132 or a set of data processing systems included therein, and/or the KPIs and reporting framework 138 or a set of data processing systems included therein.

As another example, in various embodiments, when referring to a decision of how to price a particular good, service, set of data, action, incentive, loyalty credit or redemption, or other aspect of a commerce transaction in a cryptocurrency or in a type of cryptographic tokens, such decision may be made by the omnichannel commerce platform 100 itself, or by any of the following components (or any combination of the following components) that may be included in the omnichannel commerce platform: the omnichannel layer 102 or a set of data processing systems included therein, the data management layer 120 or a set of data processing systems included therein, the blockchain 196 (or to two or more blockchains illustrated by the blockchain 196) or a set of data processing systems included therein, one or more merchants 150 or a set of data processing systems associated with or operated by such one or more merchants, one or more payment processors 152 or a set of data processing systems associated with or operated by such one or more payment processors, one or more data customers 156 or a set of data processing systems associated with or operated by such one or more data customers, one or more consumers 160 or a set of data processing systems associated with or operated by such one or more consumers, one or more other commerce service providers 158 or a set of data processing systems associated with or operated by such one or more service providers, the online shopping platform 104 or a set of data processing systems included therein, the loyalty platform 130 or a set of data processing systems included therein, the mobile app shopping platform 106 or a set of data processing systems included therein, the digital offers platform 132 or a set of data processing systems included therein, the point of sale platform 108 or a set of data processing systems included therein, the digital coupons platform 134 or a set of data processing systems included therein, the other omnichannel platform 138 or a set of data processing systems included therein, the reservations platform 136 or a set of data processing systems included therein, the consumer data management framework 122 or a set of data processing systems included therein, the merchant data management framework 124 or a set of data processing systems included therein, the vendor data management framework 126 or a set of data processing systems included therein, the deliveries data management framework 128 or a set of data processing systems included therein, the reservation data management framework 130 or a set of data processing systems included therein, the other omnichannel data frameworks 132 or a set of data processing systems included therein, and/or the KPIs and reporting framework 138 or a set of data processing systems included therein.

In various embodiments, the term “omnichannel commerce platform” may include one or more of the components described in connection with the various figures and embodiments of this patent, and does not necessarily include all of the components shown in any particular figure. For example, in various embodiments, the omnichannel commerce platform 100 described in connection with the embodiment of FIG. 1 may include one or more of the following components shown in FIG. 1: the omnichannel layer 102 and/or a set of data processing systems included therein, the data management layer 120 and/or a set of data processing systems included therein, the blockchain 196 (or to two or more blockchains illustrated by the blockchain 196) and/or a set of data processing systems included therein, one or more merchants 150 and/or a set of data processing systems associated with or operated by such one or more merchants, one or more payment processors 152 and/or a set of data processing systems associated with or operated by such one or more payment processors, one or more data customers 156 and/or a set of data processing systems associated with or operated by such one or more data customers, one or more consumers 160 and/or a set of data processing systems associated with or operated by such one or more consumers, one or more other commerce service providers 158 and/or a set of data processing systems associated with or operated by such one or more service providers, the online shopping platform 104 and/or a set of data processing systems included therein, the loyalty platform 130 and/or a set of data processing systems included therein, the mobile app shopping platform 106 and/or a set of data processing systems included therein, the digital offers platform 132 and/or a set of data processing systems included therein, the point of sale platform 108 and/or a set of data processing systems included therein, the digital coupons platform 134 and/or a set of data processing systems included therein, the other omnichannel platform 138 and/or a set of data processing systems included therein, the reservations platform 136 and/or a set of data processing systems included therein, the consumer data management framework 122 and/or a set of data processing systems included therein, the merchant data management framework 124 and/or a set of data processing systems included therein, the vendor data management framework 126 and/or a set of data processing systems included therein, the deliveries data management framework 128 and/or a set of data processing systems included therein, the reservation data management framework 130 and/or a set of data processing systems included therein, the other omnichannel data frameworks 132 and/or a set of data processing systems included therein, and/or the KPIs and reporting framework 138 and/or a set of data processing systems included therein.

FIG. 2 shows a representation of an exemplary data processing system 200 that may be used in connection with various embodiments and that may be configured to execute instructions for performing functions and methods described and/or claimed in connection with various embodiments. In various implementations, the data processing system 200 represents any of the data processing systems used by consumers 160 to receive, transmit or process commerce data in the embodiment of FIG. 1. In various implementations, the data processing system 200 represents any of the data processing systems used to implement or facilitate the operation of any of the online shopping platform 104, mobile app shopping platform 106, point of sale platform 108, loyalty platform 110, digital offers platform 112, digital coupons platform 118, reservations platform 116, other omnichannel platforms 118, consumer data management framework 122, merchant data management framework 124, vendor data management framework 126, deliveries data management framework 128, reservations data management framework 130, other omnichannel data frameworks 132, or KPIs and reporting framework 138. In various implementations, the data processing system 200 represents any of the data processing systems used to implement or facilitate the operation of the in-store or online commerce platform of merchants 150. In various implementations, the data processing system 200 represents any of the data processing systems used to implement or facilitate the operation of the technology platforms for payment processing, management, approval, verification and settlement of payment processors 152 from the embodiment of FIG. 1. In various implementations, the data processing system 200 represents any of the data processing systems used to implement or facilitate the operation of the technology platforms for management of data and analytics of data customers 156 or of the other commerce service providers from the embodiment of FIG. 1.

In various embodiments, the data processing system 200 is an electronic tablet comprising a multi-touch display sensitive screen, a mobile phone, a wearable device, a vehicle entertainment system, a vehicle navigation system, a vehicle information system, or another mobile personal communication device. Examples of electronic tablets in accordance with various embodiments include an iPad tablet computer currently commercialized by Apple Inc. and running an iOS operating system, a tablet computer running the Android operating system currently developed by Google Inc, a tablet running the Windows operating system, and any other electronic tablet devices. Examples of mobile phones in accordance with various embodiments include a mobile phone using an iOS operating system (iPhone), a mobile phone using an Android operating system, a mobile phone using a Windows operating system, and other mobile phones. Examples of wearable devices in accordance with various embodiments include a watch with an electronic display, and an electronic eyewear device (e.g., electronic glasses such as Google Glass or other devices with a similar form factor). In various embodiments, an electronic tablet or a mobile phone is adapted to run one or more mobile apps that perform various functions. Examples of a vehicle entertainment system, vehicle navigation system, or vehicle information system in accordance with various embodiments includes any device that can relay visual or auditory information to a driver or passenger in a vehicle or other transportation device (e.g., car, bus, train, plane, ship, subway, elevator, etc.), including for example a car entertainment system that can display or recite to a driver or a passenger information about a shopping menu, product or service.

The exemplary data processing system 200 includes a data processor 202. The data processor 202 represents one or more general-purpose data processing devices such as a microprocessor or other central processing unit. More particularly, the processing device may be a complex instruction set computing (CISC) microprocessor, a reduced instruction set computing (RISC) microprocessor, a very long instruction word (VLIW) microprocessor, a processor implementing other instruction sets, or a processor implementing a combination of instruction sets, whether in a single core or in a multiple core architecture. Data processor 202 may also be or include one or more special-purpose processing devices such as an application specific integrated circuit (ASIC), a field programmable gate array (FPGA), a digital signal processor (DSP), network processor, any other embedded processor, or the like. The data processor 202 may execute instructions for performing operations and steps in connection with various embodiments of the present invention. In various implementations, data processor 202 may be based on an ARM architecture commercialized by ARM Limited, x86, x32, x64 or subsequent architectures commercialized by Intel Corporation, x86-64 or subsequent architectures commercialized by Advanced Micro Devices, Inc., and/or on other processor architectures suitable that provide desirable attributes of performance, size, power consumption, packaging, features, cost, and/or other characteristics. In some embodiments (e.g. for mobile device applications), data processor 202 may be, may be included in, or may include a system on a chip (SoC) design comprising one or more CPU cores, one or more graphics processing unit (GPU), one or more wireline or wireless modems, one or more global positioning system (GPS) modules, camera functionality, gesture recognition functionality, video functionality, and/or other software and hardware features.

In this exemplary embodiment, the data processing system 200 further includes a dynamic memory 204, which may be designed to provide higher data read speeds. Examples of dynamic memory 204 include dynamic random access memory (DRAM), synchronous DRAM (SDRAM) memory, read-only memory (ROM) and flash memory. The dynamic memory 204 may be adapted to store all or part of the instructions of a software application, as these instructions are being executed or may be scheduled for execution by data processor 202. In some implementations, the dynamic memory 204 may include one or more cache memory systems that are designed to facilitate lower latency data access by the data processor 202.

In this exemplary embodiment, the data processing system 200 further includes a storage memory 206, which may be designed to store larger amounts of data. Examples of storage memory 206 include a magnetic hard disk and a flash memory module. In various implementations, the data processing system 200 may also include, or may otherwise be configured to access one or more external storage memories, such as an external memory database or other memory data bank, which may either be accessible via a local connection (e.g., a wired or wireless USB, Bluetooth, or WiFi interface), or via a network (e.g., a remote cloud-based memory volume).

A storage memory may also be denoted a memory medium, storage medium, dynamic memory, or memory. In general, a storage memory, such as the dynamic memory 204 and the storage memory 206, may include any chip, device, combination of chips and/or devices, or other structure capable of storing electronic information, whether temporarily, permanently or quasi-permanently. A memory medium could be based on any magnetic, optical, electrical, mechanical, electromechanical, MEMS, quantum, or chemical technology, or any other technology or combination of the foregoing that is capable of storing electronic information. A memory medium could be centralized, distributed, local, remote, portable, or any combination of the foregoing. Examples of memory media include a magnetic hard disk, a random access memory (RAM) module, an optical disk (e.g., DVD, CD), and a flash memory card, stick, disk or module.

A software application or module, and any other computer executable instructions, may be stored on any such storage memory, whether permanently or temporarily, including on any type of disk (e.g., a floppy disk, optical disk, CD-ROM, and other magnetic-optical disks), read-only memory (ROM), random access memory (RAM), EPROM, EEPROM, magnetic or optical card, or any other type of media suitable for storing electronic instructions.

In general, a storage memory could host a database, or a part of a database. Conversely, in general, a database could be stored completely on a particular storage memory, could be distributed across a plurality of storage memories, or could be stored on one particular storage memory and backed up or otherwise replicated over a set of other storage memories. Examples of databases include operational databases, analytical databases, data warehouses, distributed databases, end-user databases, external databases, hypermedia databases, navigational databases, in-memory databases, document-oriented databases, real-time databases and relational databases.

Storage memory 206 may include one or more software applications 208, in whole or in part, stored thereon. In general, a software application, also denoted a data processing application or an application, may include any software application, software module, function, procedure, method, class, process, or any other set of software instructions, whether implemented in programming code, firmware, or any combination of the foregoing. A software application may be in source code, assembly code, object code, or any other format. In various implementations, an application may run on more than one data processing system (e.g., using a distributed data processing model or operating in a computing cloud), or may run on a particular data processing system or logic module and may output data through one or more other data processing systems or logic modules.

The exemplary data processing system 200 may include one or more logic modules 220 and/or 221, also denoted data processing modules, or modules. Each logic module 220 and/or 221 may consist of (a) any software application, (b) any portion of any software application, where such portion can process data, (c) any data processing system, (d) any component or portion of any data processing system, where such component or portion can process data, and (e) any combination of the foregoing. In general, a logic module may be configured to perform instructions and to carry out the functionality of one or more embodiments of the present invention, whether alone or in combination with other data processing modules or with other devices or applications. Logic modules 220 and 221 are shown with dotted lines in FIG. 2 to further emphasize that data processing system 200 may include one or more logic modules, but does not have to necessarily include more than one logic module.

As an example of a logic module comprising software, logic module 221 shown in FIG. 2 consists of application 209, which may consist of one or more software programs and/or software modules. Logic module 221 may perform one or more functions if loaded on a data processing system or on a logic module that comprises a data processor.

As an example of a logic module comprising hardware, the data processor 202, dynamic memory 204 and storage memory 206 may be included in a logic module, shown in FIG. 2 as exemplary logic module 220. Examples of data processing systems that may incorporate both logic modules comprising software and logic modules comprising hardware include a desktop computer, a mobile computer, or a server computer, each being capable of running software to perform one or more functions defined in the respective software.

In general, functionality of logic modules may be consolidated in fewer logic modules (e.g., in a single logic module), or may be distributed among a larger set of logic modules. For example, separate logic modules performing a specific set of functions may be equivalent with fewer or a single logic module performing the same set of functions. Conversely, a single logic module performing a set of functions may be equivalent with a plurality of logic modules that together perform the same set of functions. In the data processing system 200 shown in FIG. 2, logic module 220 and logic module 2221 may be independent modules and may perform specific functions independent of each other. In an alternative embodiment, logic module 220 and logic module 221 may be combined in whole or in part in a single module that perform their combined functionality. In an alternative embodiment, the functionality of logic module 220 and logic module 221 may be distributed among any number of logic modules. One way to distribute functionality of one or more original logic modules among different substitute logic modules is to reconfigure the software and/or hardware components of the original logic modules. Another way to distribute functionality of one or more original logic modules among different substitute logic modules is to reconfigure software executing on the original logic modules so that it executes in a different configuration on the substitute logic modules while still achieving substantially the same functionality. Examples of logic modules that incorporate the functionality of multiple logic modules and therefore can be construed themselves as logic modules include system-on-a-chip (SoC) devices and a package on package (PoP) devices, where the integration of logic modules may be achieved in a planar direction (e.g., a processor and a storage memory disposed in the same general layer of a packaged device) and/or in a vertical direction (e.g. using two or more stacked layers).

The exemplary data processing system 200 may further include one or more input/output (I/O) ports, illustrated in FIG. 2 as I/O port 210, for communicating with other data processing system (e.g., data processing system 270), with other peripherals (e.g., peripherals 280), or with one or more networks (e.g., network 260). Each I/O port 210 may be configured to operate using one or more wired and/or wireless communication protocols, such as, for example, any protocols available in network 260, any protocols available to connect directly or indirectly to another data processing system such as data processing system 270, and/or any protocols available to connect directly or indirectly to peripherals such as Peripherals 280. In general, each I/O port 210 may be able to communicate through one or more communication channels and/or to connect to one or more networks, such as network 260 as illustrated in FIG. 2. The data processing system 200 may communicate directly with other data processing systems, such as data processing system 270 (e.g., via a direct wireless or wired connection), or via the one or more networks 260.

A communication channel or data network may include any direct or indirect data connection path, including any connection using a wireless technology (e.g., Bluetooth, infrared, WiFi, WiMAX, cellular, 3G, 4G, EDGE, CDMA and DECT), any connection using wired (also sometimes denoted “wireline”) technology (including via any serial, parallel, wired packet-based communication protocol (e.g., Ethernet, USB, FireWire, etc.), or other wireline connection), any optical channel (e.g., via a fiber optic connection or via a line-of-sight laser or LED connection), and any other point-to-point connection capable of transmitting data.

Each of the networks 260 may include one or more communication channels. In general, a network, or data network, consists of one or more communication channels that can be established between devices connected to each other directly or indirectly through that network. Examples of networks include a LAN, MAN, WAN, cellular and mobile telephony network, the Internet, the World Wide Web, and any other information transmission network. In various implementations, the data processing system 200 may include additional interfaces and communication ports in addition to the I/O Port 210.

In various embodiments, a network, such as network 260, may include a collection of terminal nodes, links and any intermediate nodes. A network maybe wired or wireless. An example of a wired network is an Ethernet network. An example of a wireless network is a WiFi network.

An example of a short-distance communication channel or network are near-field communication (NFC) applications, which are employed in some mobile devices to automate device-to-device transactions, such as payments, data synchronization, and other information exchange. Another example of a short-distance communication channel or network are radio frequency identification (RFID) data transfers that can be used to identify individual items using low-power communications (e.g., merchandize identification, automatic inventory, etc.).

In one embodiment, the data processing system 200 comprises a wireless communication module that enables the data processing system 200 to communicate wirelessly via network 260, using a wireless data protocol made available in the network 260 (e.g., a WiFi protocol). The network 260 may include both wireless and wireline connections (e.g., may permit communications using both WiFi and Ethernet protocols). In one embodiment, the network 260 may consist of two or more networks, whether wireless or wired, and the two or more networks may operate independently (e.g., to increase security by separating communications) or may be connected to each other (e.g., to facilitate communications among devices connected to different networks).

In one embodiment, the data processing system 200 is located in a particular facility (e.g., in a commercial establishment), and the network 260 represents a combination of an internal network deployed within that facility and an external communication channel or network that provides a connection to the Internet. In one embodiment, the data processing system 200 could be connected directly to the Internet through the network 260, could be connected to the Internet through an intermediate data processing system that acts as a gateway, or could be connected to the Internet through one or more networking devices, such as networking device 262 illustrated in FIG. 2 (e.g., a router, a modem, a gateway). In one embodiment, the data processing system 200 could be connected directly or indirectly to the Internet through the network 260 and could act as a gateway for one or more other data processing systems (e.g., other computing devices, peripheral devices used in point of sale or other commerce transactions, etc.).

In one embodiment, the data processing system 200 may communicate with a cloud or other remote data processing system via the network 260. In various embodiments, the cloud or other remote data processing system may assist the data processing system 200 to conduct or facilitate a commercial transaction (e.g., authenticating a user or a payment method, conducting or mediating a payment transaction, collecting or returning data or analytical information about a consumer, etc.).

In various embodiments, the network 260 is, or includes a network that facilitates communications at longer distances. In various embodiments, the network 260 is, or includes, a 3G network, a 4G network, an EDGE network, a CDMA network, a GSM network, a 3GSM network, a GPRS network, an EV-DO network, a TDMA network, an iDEN network, a DECT network, a UMTS network, a WiMAX network, a cellular network, any type of wireless network that uses a TCP/IP protocol or other type of data packet or routing protocol, any other type of wireless wide area network (WAN) or wireless metropolitan area network (MAN), or a satellite communication channel or network. Each of the foregoing types of networks that could be used within the network 260 utilizes various communication protocols, including protocols for establishing connections, transmitting and receiving data, handling various types of data communications (e.g., voice, data files, HTTP data, images, binary data, encrypted data, etc.), and otherwise managing data communications. In various embodiments, the data processing system 200 is configured to be compatible with one or more protocols used in the network 260, such that the data processing system 200 can successfully connect to the network 260 and communicate via the network 260.

The exemplary data processing system 200 may further include a display 212, which provides the ability for a user to visualize data output by the data processing system 200 and/or to interact with the data processing system 200. The display 212 may directly or indirectly provide a graphical user interface (GUI) adapted to facilitate presentation of data to a user and/or to accept input from a user. The display 212 may consist of a set of visual displays (e.g., an integrated LCD, LED or CRT display), a set of external visual displays, (e.g., an LCD display, an optical projection device, a holographic display), or of a combination of the foregoing.

A visual display may also be denoted a graphic display, computer display, display, computer screen, screen, computer panel, or panel. Examples of displays include a computer monitor, an integrated computer display, electronic paper, a flexible display, a touch panel, a transparent display, and a three dimensional (3D) display that may or may not require a user to wear assistive 3D glasses.

A data processing system may incorporate a graphic display. Examples of such data processing systems include a laptop, a computer pad or notepad, an electronic tablet or other tablet computer, a smart phone or any other mobile phone, an electronic reader (also denoted an e-reader or ereader), a personal data assistant (PDA), a medical device, or any other device that incorporates data processing features and a display for displaying information and/or receiving information from a user.

A data processing system may be connected to an external graphic display. Examples of such data processing systems include a desktop computer, a server, an embedded data processing system, a mobile phone, an electronic tablet, or any other data processing system adapted to display information through an external display, whether or not it includes a display itself. A data processing system that incorporates a graphic display may also be connected to an external display. A data processing system may directly display data on an external display, or may transmit data to other data processing systems or logic modules that will eventually display data on an external display.

Graphic displays may include active display, passive displays, LCD displays, LED displays, OLED displays, plasma displays, and any other type of visual display that is capable of displaying electronic information to a user. Such graphic displays may permit direct interaction with a user, either through direct touch by the user (e.g. a touch-screen display that can sense a user's finger touching a particular area of the display), through proximity interaction with a user (e.g., sensing a user's finger being in proximity to a particular area of the display), or through a stylus or other input device. In one implementation, the display 212 is a touch-screen display that displays a human GUI interface to a user, with the user being able to control the data processing system 200 through the human GUI interface, or to otherwise interact with, or input data into the data processing system 200 through the human GUI interface. Examples of touch-screen display technologies include resistive, surface acoustic wave, capacitive, infrared, optical imaging, dispersive signal, and acoustic pulse recognition

The exemplary data processing system 200 may further include one or more human input interfaces 214, which facilitate data entry by a user or other interaction by a user with the data processing system 200. Examples of human input devices 214 include a keyboard, a mouse (whether wired or wireless), a stylus, other wired or wireless pointer devices (e.g., a remote control), or any other user device capable of interfacing with the data processing system 200. In some implementations, human input devices 214 may include one or more sensors that provide the ability for a user to interface with the data processing system 200 via voice, or provide user intention recognition technology (including optical, facial, or gesture recognition), or gesture recognition (e.g., recognizing a set of gestures based on movement via motion sensors such as gyroscopes, accelerometers, magnetic sensors, optical sensors, etc.).

The exemplary data processing system 200 may further include one or more gyroscopes, accelerometers, magnetic sensors, optical sensors, or other sensors that are capable of detecting physical movement of the data processing system. Such movement may include larger amplitude movements (e.g., a device being lifted by a user off a table and carried away or elevation changes experienced by the data processing system), smaller amplitude movements (e.g., a device being brought closer to the face of a user or otherwise being moved in front of a user while the user is viewing content on the display, movement experienced by a vehicle within which the data processing system is located), or higher frequency movements (e.g., hand tremor of a human, vibrations caused by an engine). In the absence of internal motion sensors, or in addition to any internal motion sensors, the exemplary data processing system 200 may further be capable of receiving and processing information from external motion sensors such as gyroscopes, accelerometers, magnetic sensors, optical sensors, or other sensors that are capable of detecting physical movement of the data processing system.

The exemplary data processing system 200 may further include an audio interface 216, which provides the ability for the data processing system 200 to output sound (e.g., a speaker), to input sound (e.g., a microphone), or any combination of the foregoing.

The exemplary data processing system 200 may further include any other components that may be advantageously used in connection with receiving, processing and/or transmitting information.

In the exemplary data processing system 200, the data processor 202, dynamic memory 204, storage memory 206, I/O port 210, display 212, human input interface 214, audio interface 216, and logic module 221 communicate to each other via the data bus 219. In some implementations, there may be one or more data buses in addition to the data bus 219 that connect some or all of the components of data processing system 200, including possibly dedicated data buses that connect only a subset of such components. Each such data bus may implement open industry protocols (e.g., a PCI or PCI-Express data bus), or may implement proprietary protocols.

In one embodiment, a data processing system (such as data processing system 200) is connected to a networking device, illustrated in FIG. 2 as networking device 262. In various embodiments, the networking device 262 could act as a router (wireless and/or wired), hub, switch, modem, bridge, repeater, gateway, communication protocol converter, communication buffering device, or virtually any other type of equipment that can perform a networking or communication function. In various embodiments, the networking device 262 could perform various functions for data processing system 200, including acting as a connecting hub to other data processing systems (e.g., data processing system 270) and/or peripherals (e.g., one or more peripherals 280), providing a layer of security (e.g., acting as a firewall, providing a connection or user authentication layer, etc.), extending the range of a wireless communication channel or network (e.g., in a restaurant or other commercial establishment where data processing systems and peripherals are far from each other or are separated by metallic objects or thick walls), establishing a short-distance network (e.g., a BlueTooth network or other network intended to operate using low power or to provide physical security by limiting the effective connection range), and so on. In various embodiments, the networking device 262 may be adapted to communicate using a wired connection, such as a serial connection, a wired packet-based communication protocol (e.g., Ethernet, USB, FireWire, etc.), a parallel connection, and/or any other wireline protocol. In various embodiments, the networking device 262 may be adapted to communicate using a wireless connection, such as a WiFi connection or cellular network connection.

In one embodiment, the networking device 262 is adapted to handle data communications via a local network (e.g., network 260 in FIG. 2 could represent a local network, such as a WiFi network) with one or more local data processing systems and/or peripheral devices, such as the data processing system 270 and the peripheral devices 280. In one embodiment, the networking device 262 establishes a local network, and one or more of the data processing system 200, data processing system 270, and/or peripheral devices 280 join this local network. In another embodiment, a local network (e.g., network 260) is established by another device (e.g., by another wireless and/or wired router, by a data processing system, by a peripheral device, etc.), and the networking device 262, and one or more of the data processing system 200, data processing system 270, and/or peripheral devices 280 join this local network.

In various embodiments, a local network is a wireless network that facilitates wireless communications between devices that are deployed in a local configuration, for example being collocated within a room, building, facility or location. For example, a local network (e.g., network 260 in FIG. 2 could represent a local network) may be created within a restaurant, store, other retail location, hotel, gas station, school, employment location, or other business facility or commercial establishment, where a sale transaction or other commercial transaction could take place using one or more of the data processing system 200, data processing system 270, and/or peripheral devices 280.

In various embodiments, network 260 in FIG. 2 could represent a set of local networks, which could be, or could include, wireless and/or wired communication. In one embodiment, a local network could be a WiFi network, including any wireless network compliant with an IEEE 802.11 standard, any wireless network for local wireless communications developed by or with the assistance of the WiFi Alliance or other standard bodies or industry groups, or any other wireless local area network. In general, for various embodiments, it is desirable for a local network to be capable of establishing reliable wireless connections between two or more data processing devices and/or peripherals, even if they are not in immediate proximity.

In various embodiments, one or more data processing systems, such as the data processing system 200 of FIG. 2, may be connected directly or indirectly to a computational cloud, such as cloud 290 illustrated in FIG. 2. A computational cloud, also denoted a “cloud,” is a set of computing servers that provide computational capability, data storage and/or services capability to one or more client devices. The client devices are typically remote from the cloud and are accessing the cloud via one or more data networks. A cloud could include sophisticated computing and data storage capabilities, including advanced security, performance management, high reliability, redundancy, interoperability with various types of client devices (e.g., various types of data processing systems using different hardware and software configurations could connect to the same cloud and receive similar services), quick and cost-effective computing power provisioning, and so on. For example, in various embodiments, one or more of the data processing system 200 and the data processing system 270 may be different types of electronic tablets, mobile phones, laptops or personal computers, and they could both be connected to the cloud 290 via one or more networks (e.g., network 260 and/or other data networks). In one embodiment, one or more of the peripheral devices 280 may also be connected to the cloud 290.

A cloud, such as cloud 290, may provide access to various types of services. Services and functionality made available by clouds include Software as a Service (SAAS), Platform as a Service (PAAS), cloud computing, Infrastructure as a Service (IAAS), cloud storage, Internet-based computing, and so on. Depending on their characteristics, clouds may be classified as private clouds, public clouds, hybrid clouds, and so on.

In various embodiments, one or more Application Processing Interfaces (APIs), such as the API layer 296 illustrated in FIG. 2, may be deployed to facilitate communications between data processing systems, clouds, networks, and/or other systems or components. In general, an API may be or may include a set of subroutine definitions, protocols, and/or tools for building or interconnecting web-based systems, operating systems, database systems, hardware and/or software. API specifications may include specifications for object classes, routines, variables, data structures, and/or remote calls. An advantage of using APIs to interconnect web-based systems, operating systems, database systems, hardware and/or software may include the ability to provide a common communication framework capable of communicating with different types of hardware software or technologies (e.g., data processing systems with Android, iOS, Windows and other Operating Systems may communicate with each other, web systems running on different software environments may exchange data using common protocols, etc.). Another advantage of using APIs to interconnect web-based systems, operating systems, database systems, hardware and/or software may include introducing additional layers of security for the components connected to the API (e.g., by alleviating the need to log in directly into a remote system, by limiting the features or types of data that can be exchanged, by limiting the ability to push v. pull data from a web system or server, etc.). Another advantage of using APIs to interconnect web-based systems, operating systems, database systems, hardware and/or software may include improved scalability of communications (e.g., as the volume of calls through an API increases, additional computing resources can be provisioned on demand to process such calls, etc.).

As shown in the embodiment of FIG. 2, the API layer 296 can be used to interface a variety of different components and systems, such as the data processing system 200, the data processing system 270, the peripherals 280, one or more client device 294, and/or the cloud 290. In general, a wide range of data processing systems or components with communication capabilities could be connected to an API layer using an appropriate protocol and/or data conversion.

Web APIs are a particular class of APIs that provide functionality for interfacing data processing systems, clouds and other servers capable of communicating via the Web or Internet. A Web API may provide an interface through which interactions happen between an enterprise and applications that use its assets. When deployed as a Web API, an API such as the API layer 296 may provide a programmable interface between a set of services and a set of applications serving different types of consumers. When used in the context of web development, an API such as the API layer 296 may be defined as a set of Hypertext Transfer Protocol (HTTP) request messages, along with a definition of the structure of response messages, possibly in an Extensible Markup Language (XML) or JavaScript Object Notation (JSON) format. In a Web context, APIs such as the API layer 296 may support Simple Object Access Protocol (SOAP) based web services, service-oriented architectures (SOA), direct representational state transfer (REST) style web resources, and/or resource-oriented architecture (ROA).

In various implementations, the API layer 296 is, or is included in the API layer 190 from the embodiment of FIG. 1.

In various implementations, terms such as cloud service, cloud-based service, cloud functionality, cloud-based functionality, cloud application and/or cloud-based application are used to denote software running in a computing cloud and performing various functions. Examples of such cloud-based features may include email systems, portals for accessing information stored in the cloud, applications collecting and/or analyzing data in the cloud, applications residing in the cloud and interfacing with mobile devices (e.g., mobile phones) or other user terminals, and other similar applications, features and/or services. A particularly useful class of cloud-based services are SAAS platforms providing a wide range of functionality such as sales management, data analytics and reporting, marketing management and automation, financial management and reporting, billing and payments, and other features amenable to cloud-based deployment.

As an example, data processing system 200 may be connected to cloud 290 through one or more communication channels or networks and may store data in the cloud for backup purposes and/or to enable various cloud-based services based on that data. Correspondingly, data processing system 200 may receive data from cloud 290 on demand and/or at predefined intervals. Cloud 290 may include one or more portals for administering, monitoring, configuring, and/or controlling the data processing system 200. The portal in the cloud 290 may permit one or more users to log in and access data received from the data processing system 200 and/or otherwise available in the cloud, including records of data and data analytics. In one embodiment, a cloud may perform an authentication function for a data processing system connected to the cloud, and may be configured to remotely shut down, erase, reset, update an operating system or application, or otherwise configure or restrict the operation of a remote data processing system under various circumstances (e.g., unauthorized access of the data processing system or of a cloud portal).

In various embodiments, the data processing system 200 and other systems or components shown in the embodiment of FIG. 2 (e.g., the networking device 262, the data processing system 270, the network 260, one or more of the client devices 294, the API layer 296, etc.) may be connected to a blockchain or combination of blockchains, illustrated as blockchain 298 in FIG. 2. Blockchains were discussed in more detail in connection with the embodiment of FIG. 1. In various embodiments, the blockchain 298 may represent the blockchain 196 discussed in connection with the embodiment of FIG. 1. In various embodiments, the blockchain 298 may facilitate commerce transactions and/or smart contracts involving cryptocurrencies and/or cryptographic tokens, as generally described in connection with the embodiment of FIG. 1.

Some of the embodiments described in this application (or, upon issuance, patent) may be presented in terms of algorithms and symbolic representations of operations on data bits within a computer memory. In general, an algorithm represents a sequence of steps leading to a desired result. Such steps generally require physical manipulations of physical quantities. Usually, though not necessarily, these quantities take the form of electrical or magnetic signals capable of being stored, transferred, combined, compared, and otherwise manipulated using appropriate electronic devices. Such signals may be denoted as bits, values, elements, symbols, characters, terms, numbers, or using other similar terminology.

When used in connection with the manipulation of electronic data, terms such as processing, computing, calculating, determining, displaying, or the like, refer to the action and processes of a computer system or other electronic system that manipulates and transforms data represented as physical (electronic) quantities within the system's registers and memories into other data similarly represented as physical quantities within the memories or registers of that system of or other information storage, transmission or display devices.

Various embodiments of the present invention may be implemented using an apparatus or machine that executes programming instructions. Such an apparatus or machine may be specially constructed for the required purposes, or may comprise a general purpose computer selectively activated or reconfigured by a software application.

Algorithms discussed in connection with various embodiments are not inherently related to any particular computer or other apparatus. Various general purpose systems may be used with programs in various embodiments, or in some embodiments more specialized systems, devices or components could be deployed to perform the respective functions. Embodiments are not described with reference to any particular programming language, data transmission protocol, or data storage protocol. Instead, a variety of programming languages, transmission or storage protocols may be used to implement various embodiments.

FIG. 3 shows an omnichannel commerce platform adapted to facilitate commerce transactions between a set of consumers and a set of merchants, in accordance with an embodiment.

In the embodiment of FIG. 3, the omnichannel commerce platform 300 comprises an omnichannel layer 302 and a data management and analytics lawyer 320 adapted to facilitate commerce transactions between one or more consumers 360 and one or more merchants 350.

In one embodiment, the omnichannel layer 302 comprises online shopping platform 304, mobile app shopping platform 306, point of sale platform 308, loyalty platform 310, digital offers platform 312, digital coupons platform 318, reservations platform 316, and other omnichannel platforms 118. In one embodiment, the omnichannel layer 302 is, or includes the functionality discussed in connection with the omnichannel layer 102 from FIG. 1.

In one embodiment, the data management and analytics lawyer 320 comprises a consumer data management framework 322, merchant data management framework 324, vendor data management framework 326, deliveries data management framework 328, reservations data management framework 330, one or more of the other omnichannel data frameworks 332, and/or a KPIs and reporting framework 338.

In one embodiment, a consumer 360 utilizes a data processing system to interact with the mobile app shopping platform 306 to view one or more products and/or services available from a set of merchants 350. An example of such data processing system is a mobile phone. Other examples of such a data processing system include any of the data processing systems discussed in connection with the embodiment of FIG. 2 that are suitable to be carried or otherwise accessed by a consumer while traveling through a residential, urban or rural area. In various implementations, a consumer 360 may use a mobile phone (e.g., iPhone, Android phone, Windows phone or any other mobile phone or similar device), an electronic tablet (e.g., an iPad, an Android tablet, a Windows tablet, etc.), a wearable device (e.g., a watch with suitable display), an in-vehicle system that can display and/or relay information verbally to the consumer (e.g., a car entertainment system that can display or recite to a driver or a passenger information about a menu, product or service from a merchant 350), a laptop or other portable computer, or any other such suitable electronic device. Examples of operating systems that may be used by such data processing systems include iOS, Android, Windows, and any other proprietary or Open Source operating system.

In one embodiment, a consumer 360 is able to remotely view a set of merchants 350. In various embodiments, each merchant represents one or more merchant locations. In various embodiments, each merchant 350 may be a retail store, hotel, motel, other lodging or hospitality facility, restaurant location, quick service restaurant location (QSR), coffee shop, pizzeria, bar, liquor store, grocery store, ice cream shop, frozen yogurt shop, convenience store, gasoline station, electric car charging station, stadium, movie theater, concert hall, other music or live performance facility, winery, medical office, Governmental office (e.g., a Governmental facility that sells, distributes or otherwise offers permits, licenses, vehicular license plates, or other services), hospital, and/or any combination of the foregoing. For example, a merchant may include both a gas station and a convenience store. As another example, a merchant may be a larger hotel, and the hotel may include one or more restaurants, bars, retail locations, and/or services facilities.

In various implementations, the consumer 360 may be able to view, classify or rank the merchants 350 using various merchant data (illustrated in FIG. 3 as merchant data 380), such as geographic location of the merchants (e.g., display the merchants in the order of distance from the position of the consumer 360, proximity-based search, etc.), type of goods of services offered (e.g., food, electronic devices, entertainment, etc.), ratings of customer satisfaction (e.g., favorable or unfavorable ratings by other consumers), ratings using industry standards (e.g., number of stars for hotels or restaurants issued by specific rating authorities or reviewers, grades for health and cleanliness issued by local Governmental agencies, ecological impact ratings taking into account the environmental footprint and energy usage of merchants, etc.), historical preferences of the respective consumer 360 (e.g., a restaurant could be listed higher if the consumer 360 previously indicated a good experience at that particular merchant location or at a similar establishment), availability of digital offers and/or digital coupons, waiting time for the particular product or service offered by the merchants 350 (e.g., waiting time for restaurants), or any other types of suitable classification or ranking criteria that are used in the industry for merchants, and any combination of the foregoing.

In various embodiments, the ranking of the merchants viewed by a consumer 360 on a mobile data processing device may be based on merchant data (e.g., such as merchant data 380) retrieved from the omnichannel layer 302 and/or data management and analytics layer 320.

In various embodiments, the ranking of the merchants viewed by a consumer 360 on a mobile data processing device may be based on merchant data retrieved from the merchant data management framework 324 (e.g., address of a merchant, historical ratings of a merchant, then-current waiting time for service at a merchant, availability of compatible loyalty programs for the consumer 360, availability of digital offers or digital coupons, availability of a particular payment method, etc.), consumer data management framework 322 (e.g., historical information whether the consumer 360 previously shopped at a merchant and/or expressed a positive or negative impression, predicted interest of the consumer 360 for the products or services offered by a merchant, predicted interest of a person accompanying the consumer 360 for the products or services offered by a merchant, etc.), deliveries data management framework 328 (e.g., availability of delivery or pick-up services for a merchant), reservations data management framework 330 (e.g., availability of reservations for a merchant, historical promptness of meeting the reservation schedule by a merchant, etc.), KPIs and reporting framework 338 (e.g., key performance indicators (KPIs) and other analytics, etc.), mobile app shopping platform 306 and/or online shopping platform 304 (e.g., the availability of a digital menu and/or characteristics of the menu (e.g., extensive menu, availability of pictures of items, availability of description or ratings of items, etc.), loyalty platform 330 and/or digital offers platform 332 (e.g., availability of a then-relevant digital offer or digital coupon, etc.), reservations platform 336 (e.g., availability of a reservation and the then-current waiting time, etc.), payment processors 352 (e.g., availability of a particular payment method, etc.), other data obtained from other omnichannel data frameworks 332 and/or other omnichannel platforms 338, and any combination of the foregoing.

In one embodiment, a merchant 350 receives consumer information about one or more consumers 360. Such consumer information, also denoted as consumer data, is illustrated in FIG. 3 as consumer data 382. Consumer data may include, in various embodiments, a geographic location (e.g., information received from a data processing system used by the consumer 360, such as GPS coordinates, courser positioning information obtained from an app running on the data processing system, cell phone triangulation information received from the cellular network, etc.), a direction of movement and/or expected future location of the consumer (e.g., obtained from the data processing system of the consumer, from a calendar or other information indicating a subsequent meeting scheduled for that consumer in a particular geographic area, a scheduled route received from a mobile app running on the consumer's data processing system or in a car in which the consumer is traveling, information obtained from a cellular network or WiFi networks through which the consumer is traveling, etc.), an indication of interest in a product or service offered by the merchant (e.g., the merchant's mobile app shopping platform 306 and/or online shopping platform 304 may receive a request from the consumer to transmit a menu of the merchant or some other information related to the merchant, the consumer data management framework 322 and/or the merchant data management framework 324 may notify the merchant that the consumer has requested information about the merchant (e.g., a ranking of the merchant, a rating of the merchant, a historical record of the consumer's interactions with the merchant, etc.), the digital offers platform 332 and/or the digital coupons platform 334 of the merchant may receive a request for a digital offer or coupon from the merchant, etc.), a historical record of interactions between the merchant and the consumer (e.g., which may be received from the merchant data management framework 324 and/or the consumer data management framework 322), an indication that the consumer may be a good fit for a product or service offered by the merchant even in the absence of affirmative interest expressed by the consumer for the merchant (e.g., which may be received from the merchant data management framework 324 and/or the consumer data management framework 322), an indication of recent purchases or inquiries from the consumer for products or services offered by the merchant (e.g., which may be received from the merchant data management framework 324 and/or the consumer data management framework 322), an indication of the lack of recent purchases or inquiries from the consumer for products or services offered by the merchant (e.g., which may be received from the merchant data management framework 324 and/or the consumer data management framework 322), an indication that the consumer is in the geographic vicinity of the merchant (e.g., which may be received from a data processing system in possession of the consumer, from the merchant data management framework 324 and/or from the consumer data management framework 322), an indication that the consumer has not been in the geographic vicinity of the merchant for a certain period of time (e.g., which may be received from a data processing system in possession of the consumer, from the merchant data management framework 324 and/or from the consumer data management framework 322), and other such types of information relating to the historical, current or predicted actions of the consumer.

In one embodiment, a merchant 350 transmits to a consumer 360 a digital offer, a digital coupon, or another message inviting the consumer to visit the merchant's location. In one embodiment, a data processing system in the possession of the consumer 360 (e.g., through an app running on such data processing system (e.g., a mobile phone) in possession of the consumer), automatically negotiates with the online shopping platform 304 and/or with the mobile app shopping platform 306 of the merchant 350 an improved digital offer or digital coupon that provides the consumer 350 with a higher incentive to visit the merchant and/or to place an order with the merchant. Such negotiation may be based on a set of rules that are defined on the merchant's side and a set of rules that are defined on the consumer's side (e.g., adjust the digital offer or digital coupon to offer a discount equal to a certain percentage or to a certain Dollar amount for a number of minutes, hours or days, if the digital offer or digital coupon offers a discount equal to a certain percentage or to a certain Dollar amount then the consumer will make a corresponding purchase or reservation for a restaurant, etc.).

In various embodiments, the omnichannel commerce platform 300 may manage a set of actions using merchant data relating to one or more merchants 350 and/or consumer data relating to one or more consumers 360, where such actions may include automatically transmitting to one or more consumers 350 a set of digital offers, a set of digital coupons, and/or a set of communications (e.g., a message sent via a mobile app, a text message sent directly to the data processing system of a consumer (e.g., a mobile phone, an in-car entertainment (infotainment) system, etc.).

In various embodiments, the omnichannel commerce platform 300 may manage a set of actions using merchant data relating to one or more merchants 350 and/or consumer data relating to one or more consumers 360, where such actions may include automatically ordering and/or fulfilling certain orders from one or more consumers 360 if certain conditions are satisfied (e.g., a data processing system associated with a consumer 360 may be authorized to automatically place an order for a product or service from a merchant 350 if the price is below a certain amount, if a discount exceeds a certain level, if availability of a product or service in a certain geographic area is below a certain level or meets certain conditions, if an order placed with a different merchant is not fulfilled or is delayed for any reason, etc.).

In various embodiments, the omnichannel commerce platform 300 may manage a set of actions using merchant data relating to one or more merchants 350 and/or consumer data relating to one or more consumers 360, where such actions may include automatically negotiating with data processing systems of one or more consumers 350 a set of digital offers and/or a set of digital coupons (e.g., increasing a discount for a limited time, increasing a discount if a consumer places an order within a certain period of time, offering a free or discounted delivery option for a product sold by the merchant, etc.).

In various embodiments, the omnichannel commerce platform 300 may receive or retrieve data relating to one or more merchants 350 (e.g., merchant data 380) and/or consumer data relating to one or more consumers 360 (e.g., consumer data 382) from the omnichannel layer 302, including from one or more of the shopping platform 304, mobile app shopping platform 306, point of sale platform 308, loyalty platform 310, digital offers platform 312, digital coupons platform 318, reservations platform 316, or other omnichannel platforms 118.

In various embodiments, the omnichannel commerce platform 300 may receive or retrieve data relating to one or more merchants 350 (e.g., merchant data 380) and/or consumer data relating to one or more consumers 360 (e.g., consumer data 382), from the data management and analytics lawyer 320, including from one or more of the consumer data management framework 322, merchant data management framework 324, vendor data management framework 326, deliveries data management framework 328, reservations data management framework 330, one or more of the other omnichannel data frameworks 332, or the KPIs and reporting framework 338).

In various embodiments, the omnichannel commerce platform 300 presents to a consumer 360 a set of merchants 350 that are in the general proximity of the consumer 360. For example, a consumer 360 may be walking on a street, and the omnichannel commerce platform 300 may update continuously or from time to time a list of merchants on a data processing system (e.g., mobile phone, wearable device, etc.) in possession of the consumer 360 based on positional information (e.g., GPS and/or other locational information) retrieved from the data processing system of consumer 360, positional information retrieved from cell phone towers in communication with the data processing system in possession of the consumer 360, WiFi networks recognized or detected by the data processing system of consumer 360 and/or by the omnichannel commerce platform 300, BlueTooth signals and/or other Near Field networks or signals recognized or detected by the data processing system of consumer 360 and/or by the omnichannel commerce platform 300, the combination and relative strength of one or more networks or wireless signals (e.g., BlueTooth, WiFi, and/or other Near Field networks or signals) recognized or detected by the data processing system of consumer 360 and/or by the omnichannel commerce platform 300, communications between the data processing system of consumer 360 and other data processing systems in possession of other consumers known by the omnichannel commerce platform 300 to be in that particular geographic vicinity, and/or any combination of the foregoing. In various embodiments, a data processing system in possession of consumer 360 detects one or more BlueTooth signals, WiFi networks, and/or other Near Field networks or signals, transmits certain information about such signals or networks (e.g., relative strength, identifiers, IP numbers, protocol types, names of network or device detected, etc.), and receives from the omnichannel commerce platform 300 a positional location and/or a set of merchants in the general vicinity of the consumer 360. In one embodiment, the data processing system in possession of consumer 360 may receive a set of merchants in the general vicinity of the consumer 360 from the data management and analytics layer 320. In one embodiment, the data processing system in possession of consumer 360 may receive a set of merchants in the general vicinity of the consumer 360 from and more specifically from the merchant data management framework 324.

In various embodiments, the set of merchants received by the data processing system in possession of consumer 360 and presented to the consumer 360 for viewing (e.g., within an app running on the data processing system of the consumer 360) may be ordered based on predicted distance from the location of the consumer 360 (as such location is reported by the data processing system in possession of consumer 360 or is estimated by the omnichannel commerce platform 300).

In various embodiments, the set of merchants received by the data processing system in possession of consumer 360 and presented to the consumer 360 for viewing (e.g., within an app running on the data processing system of the consumer 360) may be ordered using at least in part a ranking based on merchant data (e.g., such as merchant data 380) retrieved from the omnichannel layer 302 and/or data management and analytics layer 320, as generally discussed above in connection with this FIG. 3.

In various embodiments, the merchant data retrieved from the omnichannel layer 302 and/or data management and analytics layer 320 and used at least in part as a basis for the ranking of the merchants presented to the consumer 360 for viewing (e.g., within an app running on the data processing system of the consumer 360) may include one or more of the following: geographic location of the merchants (e.g., display the merchants in the reverse order of distance from the position of the consumer 360, proximity-based search, etc.), type of goods of services offered (e.g., food, electronic devices, entertainment, etc.), ratings of customer satisfaction (e.g., favorable or unfavorable ratings by other consumers), ratings using industry standards (e.g., number of stars for hotels or restaurants issued by specific rating authorities or reviewers, grades for health and cleanliness issued by Governmental agencies, ecological impact ratings taking into account the environmental footprint and energy usage of merchants, etc.), historical preferences of the respective consumer 360 (e.g., a restaurant could be listed higher if the consumer 360 previously indicated a good experience at that particular merchant location or at a similar establishment), availability of digital offers and/or digital coupons, waiting time for the particular product or service offered by the merchants 350 (e.g., waiting time for restaurants), any other types of suitable classification or ranking criteria that are used in the industry for merchants, and any combination of the foregoing.

In various embodiments, the merchant data retrieved from the omnichannel layer 302 and/or from the data management and analytics layer 320 and used at least in part as a basis for the ranking of the merchants presented to the consumer 360 for viewing (e.g., within an app running on the data processing system of the consumer 360) may include one or more of the following: merchant data retrieved from the merchant data management framework 324 (e.g., address of a merchant, historical ratings of a merchant, then-current waiting time for service at a merchant, availability of compatible loyalty programs for the consumer 360, availability of digital offers or digital coupons, availability of a particular payment method, etc.), consumer data management framework 322 (e.g., historical information whether the consumer 360 previously shopped at a merchant and/or expressed a positive or negative impression, predicted interest of the consumer 360 for the products or services offered by a merchant, predicted interest of a person accompanying the consumer 360 for the products or services offered by a merchant, etc.), deliveries data management framework 328 (e.g., availability of delivery or pick-up services for a merchant), reservations data management framework 330 (e.g., availability of reservations for a merchant, historical promptness of meeting the reservation schedule by a merchant, etc.), KPIs and reporting framework 338 (e.g., key performance indicators (KPIs) and other analytics, etc.), mobile app shopping platform 306 and/or online shopping platform 304 (e.g., the availability of a digital menu and/or characteristics of the menu (e.g., extensive menu, availability of pictures of items, availability of description or ratings of items, etc.), loyalty platform 330 and/or digital offers platform 332 (e.g., availability of a then-relevant digital offer or digital coupon, etc.), reservations platform 336 (e.g., availability of a reservation and the then-current waiting time, etc.), payment processors 352 (e.g., availability of a particular payment method, etc.), other data obtained from other omnichannel data frameworks 332 and/or other omnichannel platforms 338, and any combination of the foregoing.

In various embodiments, the set of merchants received by the data processing system in possession of consumer 360 and/or presented to the consumer 360 for viewing (e.g., within an app running on the data processing system of the consumer 360) may be ordered using at least in part a ranking based on consumer data (such as consumer data 382) retrieved from the omnichannel layer 302 and/or data management and analytics layer 320. In various embodiments, such consumer data may include one or more of the following: a geographic location (e.g., information received from a data processing system used by the consumer 360, such as GPS coordinates, courser positioning information obtained from an app running on the data processing system, cell phone triangulation information received from the cellular network, etc.), a direction of movement and/or expected future location of the consumer (e.g., obtained from the data processing system of the consumer, from a calendar or other information indicating a subsequent meeting scheduled for that consumer in a particular geographic area, a scheduled route received from a mobile app running on the consumer's data processing system or in a car in which the consumer is traveling, information obtained from a cellular network or WiFi networks through which the consumer is traveling, etc.), an indication of interest in a product or service offered by the merchant (e.g., the merchant's mobile app shopping platform 306 and/or online shopping platform 304 may receive a request from the consumer to transmit a menu of the merchant or some other information related to the merchant, the consumer data management framework 322 and/or the merchant data management framework 324 may notify the merchant that the consumer has requested information about the merchant (e.g., a ranking of the merchant, a rating of the merchant, a historical record of the consumer's interactions with the merchant, etc.), the digital offers platform 332 and/or the digital coupons platform 334 of the merchant may receive a request for a digital offer or coupon from the merchant, etc.), a historical record of interactions between the merchant and the consumer (e.g., which may be received from the merchant data management framework 324 and/or the consumer data management framework 322), an indication that the consumer may be a good fit for a product or service offered by the merchant even in the absence of affirmative interest expressed by the consumer for the merchant (e.g., which may be received from the merchant data management framework 324 and/or the consumer data management framework 322), an indication of recent purchases or inquiries from the consumer for products or services offered by the merchant (e.g., which may be received from the merchant data management framework 324 and/or the consumer data management framework 322), an indication of the lack of recent purchases or inquiries from the consumer for products or services offered by the merchant (e.g., which may be received from the merchant data management framework 324 and/or the consumer data management framework 322), an indication that the consumer is in the geographic vicinity of the merchant (e.g., which may be received from a data processing system in possession of the consumer, from the merchant data management framework 324 and/or from the consumer data management framework 322), an indication that the consumer has not been in the geographic vicinity of the merchant for a certain period of time (e.g., which may be received from a data processing system in possession of the consumer, from the merchant data management framework 324 and/or from the consumer data management framework 322), and other such types of information relating to the historical, current or predicted actions of the consumer.

In various embodiments, merchant data retrieved from the omnichannel layer 302 and/or data management and analytics layer 320 is used at least in part to identify one or more merchants 350 for which an ordering environment is automatically downloaded to the data processing system in possession of a consumer 360 for viewing by the consumer (e.g., within an app running on the data processing system of the consumer 360).

In various embodiments, merchant data retrieved from the omnichannel layer 302 and/or data management and analytics layer 320 is used at least in part to identify one or more merchants 350 for which an ordering environment is automatically downloaded to the data processing systems in possession of more than one consumers 360 for viewing by the consumers (e.g., within an app running on the data processing system of each of those consumers 360). In some embodiments, the set of merchants 350 for which a shopping or ordering environment is automatically downloaded to the data processing systems in possession of the consumers 360 may be the same for all such consumers. For example, consumers who are present within a certain geographic area, such as inside a mall or on a street with high merchant density, may receive on their data processing systems (e.g., on their mobile phones or wearable devices) ordering environments from the same set of merchants 350. In some embodiments, the set of merchants 350 for which ordering environments are automatically downloaded to the data processing systems in possession of the consumers 360 may vary for individual consumers, possibly based on a ranking of the merchants. For example, consumers who are within a certain geographic area, such as inside a mall or on a shopping street, may receive ordering environments from a different number of merchants, with the set of merchants being the same for some consumers, partially different for some consumers, and completely different for some consumers.

In various embodiments, an ordering environment corresponding to a merchant 350 and transmitted to a data processing system in possession of a consumer 360 may be an ordering interface for a restaurant. In various embodiments, an ordering interface for a restaurant may include a menu for the restaurant, including a set of foods, beverages, ingredients, food modifiers (e.g., more or less of an ingredient, omitting an ingredient (e.g., salt or tomatoes), large or small size, etc.), beverage modifiers (e.g., size of a drink, diet v. regular drink, iced v. hot, etc.), meals, combos, combinations of food items, prices, discounts, loyalty information, digital offers, digital coupons, descriptions, pictures, ratings, comments from consumers, comments from food critics or other reviewers, delivery options, pickup options, ordering options, waiting times, order scheduling options (e.g., delaying fulfillment of an order or placing the order for immediate fulfillment), and/or any combination of the foregoing.

In various embodiments, an ordering environment corresponding to a merchant 350 and transmitted to a data processing system in possession of a consumer 360 may be an ordering interface for a retail shop. In various embodiments, an ordering interface for a retail shop may include a retail inventory for the retail shop, including a set of merchandise items, merchandise attributes (e.g., color or size of an article of clothing, voltage compatibility of an electronic device, size of a memory card, etc.), combos, combinations of merchandise items, prices, discounts, loyalty information, digital offers, digital coupons, descriptions, pictures, ratings, comments from consumers, comments from merchandise critics or other reviewers, delivery options, pickup options, ordering options, waiting times, order scheduling options (e.g., delaying fulfillment of an order or placing the order for immediate fulfillment), and/or any combination of the foregoing.

In various embodiments, an ordering environment corresponding to a merchant 350 and transmitted to a data processing system in possession of a consumer 360 may be an ordering interface for a hotel or other lodging facility. In various embodiments, an ordering interface for a hotel or other lodging facility may include a set of rooms, apartments, cabins and/or houses available for rent, including attributes (e.g., size of a room or apartment, type of rental unit, number of rooms, number and type of beds, number of bathrooms, floor level, view, distance from elevator, accessibility for persons with disabilities, etc.), combinations of rental units for group reservations, prices, discounts, loyalty information, digital offers, digital coupons, descriptions, pictures, ratings, comments from consumers, comments from hospitality critics or other reviewers, ordering options, waiting times, order scheduling options (e.g., delaying rental under an order or placing the order for immediate rental), and/or any combination of the foregoing.

In various embodiments, an ordering interface for a hotel or other lodging facility may include am option for a consumer to bypass the check-in counter and proceed directly to a room in the hotel or lodging facility, where the consumer may receive direct access to the room and automatically check into the room. In various embodiments, a merchant rental fulfillment system, such as a mobile app shopping platform 306 illustrated in the embodiment of FIG. 3, could automatically authenticate the consumer using one or more identification and authentication methods. In various embodiments, such authentication methods may include establishing a direct connection with an app running on the data processing system of a consumer 360 and exchanging an authentication message, receiving an identifier from the data processing system (e.g., a customer ID, username and/or password, etc.), receiving a payment from the data processing system (e.g., through an app or through an electronic wallet), receiving a payment from the consumer 360 (e.g., through a credit card run through a magnetic card reader, chip reader, contact reader, or wireless reader located on or near the door of the room being rented), receiving an authenticated communication verbally from the consumer, recognizing one or more biometric features of the consumer (e.g., facial recognition, voice, fingerprint, iris, etc.), and so on. In various embodiments, upon authenticating the consumer, the rental of the unit could automatically commence and a payment may automatically be secured or scheduled from the consumer via the omnichannel layer 302 and/or a payment processor 352, without the need to visit a traditional hotel check-in counter.

In various embodiments, an ordering environment corresponding to a merchant 350 and transmitted to a data processing system in possession of a consumer 360 may be an ordering interface for a services facility. In various embodiments, an ordering interface for a services facility may include a set of services, service attributes or modifiers (e.g., duration of a massage, type of a car wash, type and duration of a car rental, type of a service to be received from a Governmental agency, etc.), combinations of services, prices, discounts, loyalty information, digital offers, digital coupons, descriptions, pictures, ratings, comments from consumers, comments from critics or other reviewers, ordering options, waiting times, order scheduling options (e.g., delaying a service under an order or placing the order for immediate service), and/or any combination of the foregoing.

In various embodiments, a reason for automatically downloading an ordering environment for one or more merchants to a data processing system of a consumer is to improve responsiveness and the user experience for the consumer when viewing the ordering environment. For example, data rates or signal strength available to a data processing system of a consumer may be too low to receive an ordering environment on demand, which could mean that a consumer may need to wait for an ordering environment to load, or may experience delays when clicking on options or ordering items in an app for that merchant. This may happen, for example, when an ordering environment includes many pictures (e.g., a restaurant menu with many or high resolution pictures of food items, a retail inventory ordering interface with many or high resolution pictures of retail items, pictures about a merchant's store or facility, etc.), may be large in size (e.g., a large restaurant menu, a retail inventory interface with many items, etc.), videos (e.g., marketing videos, descriptions of items, informational videos, consumer testimonials, etc.), and other items that may take a longer time to be transmitted, or a longer time to be processed by the data processing system of the consumer (e.g., decompressed, decrypted, etc.).

In various embodiments, the omnichannel commerce platform and/or an app running on the data processing system of a consumer 360 may uniquely identify a merchant 350 and present that merchant's ordering environment to the consumer via the data processing system of the consumer (e.g., in an app running on a mobile phone or wearable device). This may happen, for example, if the omnichannel commerce platform and/or an app running on the data processing system of a consumer 360 may have a high degree of confidence that the consumer is interested in a particular merchant based on a set of merchant data and consumer data. In various embodiments, such merchant data and consumer data may include consumer data and/or merchant data retrieved from a data management and analytics layer and/or omnichannel layer, positional data received from the data processing system of the consumer (e.g., GPS, local WiFi networks or other wireless networks sensed by the data processing system, and/or other geographic positional information available to the data processing system and/or omnichannel commerce platform), and/or other similar data.

In various embodiments, to identify a particular merchant 350 for which a consumer 360 wants to view an ordering environment, a consumer 360 may affirmatively identify the merchant using a data processing system in the consumer's possession (e.g., through an app running on a mobile phone or on a wearable device). In various embodiments, the consumer may select the merchant from a list of merchants presented on the data processing system, possibly from a set of merchants ranked as discussed in this patent. In various embodiments, the consumer may select the merchant from a list of merchants presented on the data processing system on a map or layout, such as a geographic map, a layout or schematic of a mall, a layout of a street with merchant locations, etc. In various embodiments, the consumer may find the merchant by searching through the data processing system, such as a search entered using the address of the merchant, the name of the merchant, etc. In various embodiments, a search of a merchant that is initiated by a consumer on the consumer's data processing system may be enhanced or facilitated by the data processing system and/or by the omnichannel commerce platform by using consumer data and/or merchant data retrieved from a data management and analytics layer and/or omnichannel layer (e.g., assuming a higher probability that the consumer is seeking a business that is in close proximity and which the consumer had visited in the past (whether at the same location or at a different location that is part of the same the Enterprise chain), filling in the name or address of businesses that are physically proximate to the consumer and that are likely to be of interest to the consumer based on the consumer's historical shopping behavior, suggesting a restaurant rather than a retail store around noon or around dinner time, etc.).

In various embodiments, the consumer may use its data processing system (e.g., an app running on a mobile phone) to scan a bar code or other unique merchant identifier visible in the location of the merchant (e.g., the consumer may scan a bar code affixed to a door, wall or window in a restaurant, retail store or other merchant facility). Examples of bar codes that could be available at a merchant location to help the consumer uniquely identify the merchant and/or to automatically download the ordering environment of the merchant may include a ID barcode (e.g., UPC code, codebar, interleaved bar, etc.), a 2D barcode (e.g., data matrix code, QR code, etc.).

In various embodiments, the consumer may use its data processing system (e.g., an app running on a mobile phone) to take a picture or film a video of the merchant's facility from the outside or from inside the facility, and the data processing system and/or the omnichannel commerce platform may use that picture or video to uniquely identify the merchant and automatically present the merchant's ordering environment to the consumer via the data processing system. In various embodiments, this identification of the merchant may be done by comparing that picture or video with pictures, videos and/or other information available as part of merchant data, where such pictures, videos and/or other information may be stored on the data processing system and/or may be retrieved from a data management and analytics layer (e.g., from a merchant data management framework such as merchant data management framework 324 in the embodiment of FIG. 3) and/or from an omnichannel layer (e.g., from a mobile app shopping platform such as the mobile app shopping platform 306 in the embodiment of FIG. 3).

In various embodiments, one or more pictures and/or videos, taken by consumers in connection with the consumer's attempts to uniquely identify merchants are stored in the data management and analytics layer and are used to further augment and enhance the merchant data stored in a data management and analytics layer (e.g., in a merchant data management framework such as merchant data management framework 324 in the embodiment of FIG. 3) and/or the consumer data stored in a data management and analytics layer (e.g., in a consumer data management framework such as consumer data management framework 322 in the embodiment of FIG. 3). In various embodiments, this approach helps the omnichannel platform 300 to use information received from a set of consumers 360 to continually updated and refine the merchant and/or consumer data stored in a data management and analytics layer, such as the data management and analytics layer 320 from the embodiment of FIG. 3.

In various embodiments, various transactions and activities discussed above in connection with the embodiment of FIG. 3 may involve transactions or communications involving a blockchain or combination of blockchains, illustrated in FIG. 3 as blockchain 396. In various embodiments, such transactions may involve purchases or sales of goods or services, the transmission of funds, the receipt of funds, credits, debits, the purchase or sale of commerce data, the redemption or accumulation of loyalty credits and/or smart contracts made using one or more cryptocurrencies and/or one or more types of cryptographic tokens, as further described in connection with the embodiment of FIG. 1. Blockchains, cryptocurrencies, cryptographic tokens and smart contracts were discussed in more detail in connection with the embodiment of FIG. 1. In various embodiments, the blockchain 396 may represent the blockchain 196 discussed in connection with the embodiment of FIG. 1. In various embodiments, the blockchain 396 may facilitate commerce transactions, activities, incentives, rewards, and/or smart contracts involving cryptocurrencies and/or cryptographic tokens, as generally described in connection with the embodiment of FIG. 1.

In various embodiments, transactions involving one or more consumers 360, one or more merchants 350, one or more payment processors 352, the omnichannel layer 302 (and/or any platform included in the omnichannel layer 302), the data management and analytics layer 320 (and/or any framework included in the data management and analytics layer 320), and/or the API layer 390, as discussed in connection with the embodiment of FIG. 3, may involve one or more blockchains (illustrated by the blockchain 396), one or more cryptocurrencies, one or more types of cryptographic tokens, and/or one or more smart contracts, as generally discussed in connection with the embodiment of FIG. 1.

In various embodiments, transactions involving one or more consumers 360, one or more merchants 350, one or more payment processors 352, the omnichannel layer 302 (and/or any platform included in the omnichannel layer 302), the data management and analytics layer 320 (and/or any framework included in the data management and analytics layer 320), and/or the API layer 390, as discussed in connection with the embodiment of FIG. 3, may involve purchases or sales of goods or services, the transmission of funds, the receipt of funds, credits, debits, the purchase or sale of commerce data, the redemption or accumulation of loyalty credits and/or smart contracts made using one or more cryptocurrencies and/or one or more types of cryptographic tokens, as further described in connection with the embodiment of FIG. 1.

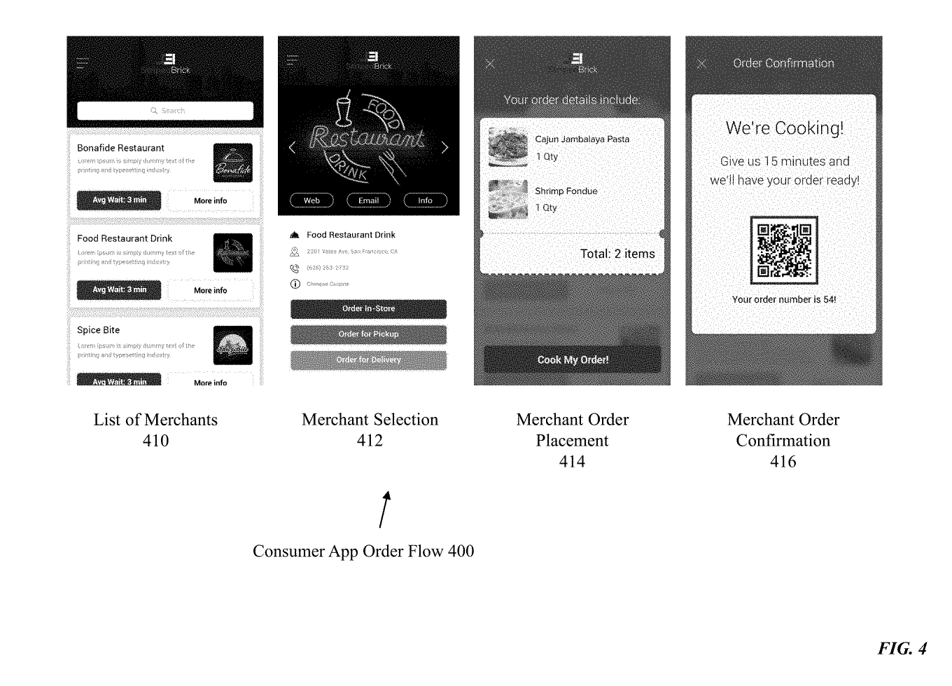

FIG. 4 shows an example of an ordering environment for a restaurant, together with an example flow of an order placed by a consumer via a mobile app running on a data processing system associated with the consumer (e.g., on a mobile phone), in accordance with an embodiment. In the embodiment of FIG. 4, the flow of the order is illustrated by consumer app order flow 400.

In various embodiments, the consumer placing the order in connection with FIG. 4 is a consumer 160 from the embodiment of FIG. 1 or a consumer 360 from the embodiment of FIG. 3. In various embodiments, the merchant receiving the order in connection with FIG. 4 is a merchant 150 from the embodiment of FIG. 1 or a merchant 350 from the embodiment of FIG. 3.

In one embodiment, the consumer app order flow 400 comprises a first step in which a consumer obtains a list of merchants in a mobile app running on the consumer's data processing system. In one embodiment, the list of merchants may be based on certain merchant data retrieved by the consumer's data processing system, as discussed in connection with the embodiment of FIG. 3. In one embodiment, an omnichannel commerce platform, such as the omnichannel commerce platform 300 from the embodiment of FIG. 3, may manage the retrieval and filtering of the merchant data and of the list of merchants presented to the consumer. Merchant data and the listing and ranking of merchants was discussed in more detail in connection with the embodiment of FIG. 3.

In one embodiment, based on the listing or ranking of merchants from the list of merchants 400, the consumer may then select a merchant that satisfies certain criteria of interest to the consumer. This step is illustrated in FIG. 4 as the merchant selection 412. For example, as discussed in more detail in connection with the embodiment of FIG. 3, certain merchant data and/or consumer data may indicate to the consumer that the type of food offered by this particular merchant is particularly good, that the consumer or a friend or relative of the consumer had previously enjoyed the services offered by this particular merchant, or the merchant may have issued to the consumer a digital offer or digital coupon that was sufficiently attractive for the consumer to select the merchant.

In one embodiment, the merchant selection 412 may be automatic, made by the data processing system and/or by an omnichannel commerce platform without any affirmative selection from the consumer. Automatic selection of a merchant based on various merchant data, consumer data and/or other positional data retrieved from the data processing system of a consumer was discussed in more detail in connection with the embodiment of FIG. 3.

In one embodiment, the mobile app running the consumer's data processing system then accesses an ordering environment for that merchant. In the embodiment of FIG. 4, the screens illustrated in steps 412, 414 and 416 show portions of the ordering environment retrieved for the merchant that was selected from the list of merchants 410.

In various embodiments, the ordering environment illustrated in steps 412, 414 and 416 was automatically downloaded by the data processing system of the consumer as discussed in connection with the embodiment of FIG. 3. For example, the ordering environment illustrated in steps 412, 414 and 416 may have been downloaded automatically together with the ordering environment of one or more other merchants included in the list of merchants 410. As another example, the ordering environment illustrated in steps 412, 414 and 416 may have been downloaded automatically once the data processing system of the consumer and/or the omnichannel commerce platform reached a minimum level of confidence that this particular merchant was the object of the consumer's interest, and no other ordering environments for any other merchants from the list of merchants 410 were downloaded to the data processing system at that time.

In various embodiments, the ordering environment illustrated in steps 412, 414 and 416 was downloaded by the data processing system of the consumer (e.g., an app running on a mobile phone or on a wearable device such as a watch or electronic eyewear device (e.g., electronic glasses such as Google Glass or other devices with a similar form factor) of the consumer) in response to an affirmative request from the consumer, as discussed in connection with the embodiment of FIG. 3. For example, the consumer may have selected a particular merchant from the list of merchants 410, and the ordering environment was downloaded to the consumer's data processing system only after that selection was made by the consumer.

In various embodiments, the consumer then accesses a set of food items from the ordering environment of that merchant, whether the full menu of the merchant, a portion of the menu, or a set of specific food items. In one embodiment, the mobile app shopping platform of the merchant may transmit the set of food items. In one embodiment, an omnichannel commerce platform may transmit the set of food items. In various embodiments, one or more of the food items displayed to the consumer may be accompanies by digital offers or digital coupons issued based on relevant consumer information and/or merchant information. In various embodiments, the price for one or more of the food items displayed to the consumer may be adjusted based on relevant consumer information and/or merchant information. For example, it may be in the interest of the merchant to sell more of a food item if it is likely that the respective food item may be left over at the end of the day and therefore be spoiled, so the price for that food item may be decreased dynamically or the amount of a corresponding coupon or offer may be increased. As another example, one food item may be in short supply, or an ingredient needed for that food item may be in short supply, so the price for that food item may be increased dynamically.

In one embodiment, the consumer then selects one or more items and places an order, as illustrated by merchant order placement 412. In one embodiment, the order is placed directly through the mobile app that displayed the list of items. In one embodiment, the order is placed via a phone call placed by the consumer to the merchant. In one embodiment, the consumer pays for the order directly through the mobile app that displayed the list of items (e.g., using a credit card number stored in the app and transmitted to the merchant's mobile app shopping platform, using a tokenized credit card stored in the mobile app, using a payment wallet available on the same data processing system (e.g., Apple Pay, Android Pay, etc.)). In one embodiment, the payment for the order is made via a phone call placed by the consumer to the merchant. In one embodiment, the payment for the order is temporarily deferred and is made subsequently, when the consumer visits the merchant's location to pick up the order.

In one embodiment, the consumer then receives a confirmation in the app that placed the order, illustrated by merchant order confirmation 412. In one embodiment, the confirmation may be sent by the mobile app shopping platform of the merchant, and may present to the consumer information about the projected duration for the order to be completed, an order number, a digital id or bar code that the consumer can use to identify the order at the merchant location, and/or a digital id or bar code that the merchant can use to identify the consumer at the merchant location.

In the embodiment of FIG. 4, the description centered around an ordering environment for a restaurant. A similar ordering process may be used in various embodiments for other types of merchants, such as retail merchants, ticketing merchants, merchants operating entertainment venues, gas station operators, and so on.

In one embodiment, a mobile app running on a data processing system of a consumer who approaches or enters a particular merchant location automatically downloads a menu, product and/or services inventory, price list, digital offers, digital coupons, other merchant data, and/or other commerce data relevant to that merchant. For example, in one embodiment, the merchant selection 412 screen may be shown automatically to a consumer by a mobile app running on that consumer's data processing system (e.g., on a mobile phone). In various embodiments, this automatic download could be managed by a mobile app shopping platform or online shopping platform of the merchant, or by another platform or data framework of an omnichannel commerce platform. In various embodiments, this automatic download may occur based on various merchant data and/or consumer data. In one embodiment, this automatic download occurs in response to the consumer's data processing system being recognized by a WiFi network, BlueTooth network, or other Near Field network or signal present in the merchant's facility, or in proximity to the merchant's facility. In one embodiment, this automatic download occurs in response to the consumer's data processing system requesting the download. For example, a data processing system may request such a download after scanning a bar code in the merchant's facility, after receiving an input from the consumer requesting the download, or after recognizing a WiFi, BlueTooth, or other Near Field network or signal at the merchant's location.

In one embodiment, an omnichannel commerce platform may utilize mobile apps deployed on various consumer data processing systems to map and establish unique identifiers for each merchant location based on the combination and relative strength of one or more WiFi networks, BlueTooth networks, and/or other Near Field networks or signals available at, or around each merchant location. Such systematic mapping of wireless signals may allow an omnichannel commerce platform to automatically download the menus and other merchant data for the appropriate merchants in the vicinity of a consumer, which could expedite the ordering process and improve the experience of both merchants and consumers engaged in commerce transactions. In one embodiment, an omnichannel commerce platform may utilize the data received from consumers to enhance its mapping of merchants and the merchant data stored in the data management and analytics layer, such as the data management and analytics layer 320 from the embodiment of FIG. 3.

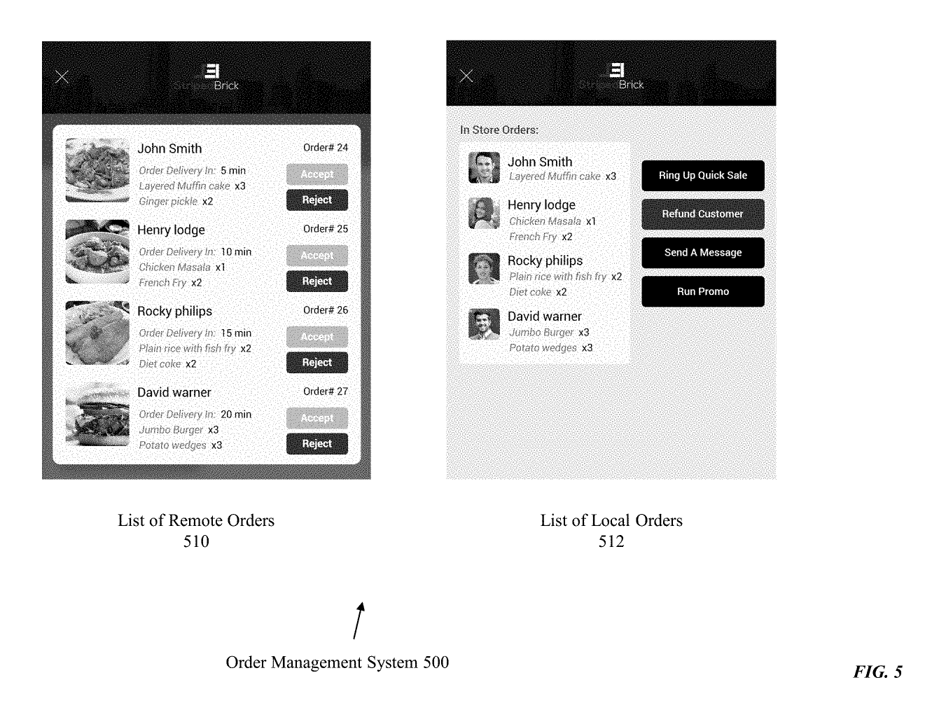

FIG. 5 shows an order management system that allows a merchant to visualize orders placed by consumers both remotely and locally, in accordance with an embodiment. In the embodiment of FIG. 5, the order management system of the merchant is illustrated by order management system 500.

In the embodiment of FIG. 5, a list of remote orders 510 shows one or more orders placed by consumers remotely. In various embodiments, the orders shown in the list of remote orders 510 may be received via an online shopping platform, such as the online shopping platform 104 from the embodiment of FIG. 1 or the online shopping platform 304 from the from the embodiment of FIG. 3, or via a mobile app shopping platform, such as the mobile app shopping platform 106 from the embodiment of FIG. 1, or the mobile app shopping platform 306 from the embodiment of FIG. 3. In one embodiment, one or more of the orders shown in the list of remote orders 510 was placed using a consumer app order flow such as the consumer app order flow 400 from the embodiment of FIG. 4.

In various embodiments, the consumers placing the orders in connection with FIG. 4 is a consumer 160 from the embodiment of FIG. 1 or a consumer 360 from the embodiment of FIG. 3. In various embodiments, the merchant receiving the order in connection with FIG. 4 is a merchant 150 from the embodiment of FIG. 1 or a merchant 350 from the embodiment of FIG. 3.

In various embodiments, the orders shown in the list of remote orders 510 may be prioritized based on various consumer data, merchant data, and or merchant-specific rules. For example, in some instances, an order placed by a consumer who has a good preexisting relationship with the merchant may be prioritized to preserve the relationship and reward the consumer for shopping loyalty. As another example, in other instances, an order placed by a consumer who does not have a preexisting relationship with the merchant, or who has not visited the merchant in a while, may be prioritized to create a good impression on the consumer. Other criteria for prioritizing or deprioritizing orders may include the time when the consumer requested completion of the order, the distance of the consumer from the location of the merchant (e.g., as retrieved from the consumer's data processing system or from other platforms or data frameworks available to an omnichannel commerce platform such as the omnichannel commerce platform 100 from the embodiment of FIG. 1 or the omnichannel commerce platform 300 from the embodiment of FIG. 3), the value of the order, the expected duration to prepare and complete the order, and other criteria or metrics derived from relevant consumer data and/or merchant data. In some embodiments, this prioritization or de-prioritization may be made automatically by a mobile app shopping platform or online shopping platform of the merchant, or by another platform or data framework of an omnichannel commerce platform. In some embodiments, updated consumer data and/or merchant data may result in automatic reprioritization of one or more orders in the list of remove orders 510. For example, updated location information received from a consumer's data processing system (e.g., updated GPS coordinates received from the mobile phone of a consumer) showing that the consumer is likely to arrive later may lead to a de-prioritization of that consumer's order. In some embodiments, this prioritization or de-prioritization may be made by a person affiliated with the merchant, such as a merchant cashier or other merchant personnel.

In one embodiment, a merchant may reject one or more orders based on various consumer data, merchant data, and or merchant-specific rules. For example, in some instances, a merchant may reject an order placed by a consumer who has declined to pay in advance for the order and has a history of failure to pick up and pay for orders (whether from this merchant and/or from other merchants), as indicated by consumer data retrieved from a consumer data management framework and/or a merchant data retrieved from a merchant data management framework. As another example, in other instances, a merchant may choose to reject an order placed by a consumer when the merchant's business is very busy and the order relies on high discounts, has a low price, requires significant customization, or takes too many resources to complete relative to the order value. Other criteria for rejecting orders may include the time when the consumer requested completion of the order, the distance of the consumer from the location of the merchant (e.g., as retrieved from the consumer's data processing system or from other platforms or data frameworks available to an omnichannel commerce platform such as the omnichannel commerce platform 100 from the embodiment of FIG. 1 or the omnichannel commerce platform 300 from the embodiment of FIG. 3), the value of the order relative to other orders pending fulfillment, the expected duration to prepare and complete the order, and other criteria or metrics derived from relevant consumer data and/or merchant data. In some embodiments, the rejection of orders may be made automatically by a mobile app shopping platform or online shopping platform of the merchant, or by another platform or data framework of an omnichannel commerce platform. In some embodiments, updated consumer data and/or merchant data may result in automatic rejection of one or more orders in the list of remove orders 510 although the order was not rejected initially (e.g., a merchant order confirmation screen, such as the merchant order confirmation 412 from the embodiment of FIG. 4, may initially indicate to the consumer that the order is pending, while seeking additional consumer data and/or merchant data to make a final decision on whether to accept or reject the order). In one embodiment, updated location information received from a consumer's data processing system (e.g., updated GPS coordinates received from the mobile phone of a consumer) showing that the consumer is likely to arrive too fast or too late relative to other orders in the merchant's queue may lead to a delayed rejection of that consumer's order. In some embodiments, the rejection of an order may be made by a person affiliated with the merchant, such as a merchant cashier or other merchant personnel.

In one embodiment, the order management system 500 includes a list of local orders, illustrated in FIG. 5 as list of local orders 512. In various embodiments, the orders listed in list of local orders 512 are orders placed by consumers physically present at the location of the merchant. In various embodiments, the orders included in the list of local orders 512 may be prioritized based on various consumer data, merchant data, and or merchant-specific rules as discussed above in connection with the list of remote orders, with appropriate modifications. For example, since the consumer who placed an order is already in the store, there is no need to retrieve additional GPS or other location information from the consumer's data processing system, but such location information from other consumers who placed remote orders may lead to an increase or decrease in the prioritization level of that local consumer.

In various embodiments, the consumers who placed remote orders are prioritized or reprioritized solely relative to other consumers who placed remote orders. In various embodiments, the local consumers who placed in-store orders are prioritized or reprioritized solely relative to other local consumers who placed in-store orders. In various embodiments, consumers who placed remote orders and local consumers who placed in-store orders are prioritized or reprioritized relative to all other consumers who placed remote orders.

FIG. 6 shows an omnichannel commerce platform adapted to make available an ordering environment of a merchant to multiple consumers, where the ordering environment is customized for one or more of the consumers, in accordance with an embodiment. In the embodiment of FIG. 6, the omnichannel commerce platform is illustrated by omnichannel commerce platform 600, and the consumers are illustrated as consumers 660, 662, 664, and 668.

In the embodiment of FIG. 6, the omnichannel commerce platform 600 includes an omnichannel layer 602, a data management and analytics layer 620 and an API layer 690. Various platforms and data management platforms included in the omnichannel layer 602 and respectively data management and analytics layer 620 are shown in FIG. 6 and in various embodiments may be similar to those discussed in connection with FIG. 1 and FIG. 3.

While the embodiment of FIG. 6 shows four consumers, illustrated as consumers 660, 662, 664, and 668, this is just an example to facilitate the description in connection with the embodiment of FIG. 6. In general, there may be one, two, or more consumers for which customization of an ordering environment may occur in accordance with various embodiments.

In various embodiments, any of the consumers 660, 662, 664, and 668 may be a consumer 160 from the embodiment of FIG. 1 or a consumer 360 from the embodiment of FIG. 3. In various embodiments, the merchant may be a merchant 150 from the embodiment of FIG. 1 or a merchant 350 from the embodiment of FIG. 3.

In various embodiments, the omnichannel commerce platform 600 may receive or retrieve data relating to merchant 650 (e.g., such as the merchant data discussed in connection with the embodiment of FIG. 3) and/or consumer data relating to one or more of the consumers 660, 662, 664, and 668 (e.g., such as the consumer data discussed in connection with the embodiment of FIG. 3), from the data management and analytics lawyer 620, including from one or more of the consumer data management framework 622, merchant data management framework 624, vendor data management framework 626, deliveries data management framework 628, reservations data management framework 630, one or more of the other omnichannel data frameworks 632, or the KPIs and reporting framework 638).

In various embodiments, based on the merchant data relating to a merchant (e.g., merchant 650) and/or based on consumer data related to a consumer (e.g., consumer 660), the omnichannel commerce platform 600 downloads an ordering environment related to the merchant that is customized for the respective consumer. In various embodiments, such customization may include customized presentation of the food items, retail items, or services presented to the consumer for purchase or selection in terms of order or rank, emphasis, presentation, description, images, comments from consumers or other reviewers, order fulfillment time, delivery options, pickup options, and/or personalized messages for the consumer. In various embodiments, such customization may consist of customized pricing, digital offers, digital coupons, loyalty offers, and/or payment options presented to the consumer.

Customization of a merchant ordering environment for one or more consumers in accordance with various embodiments is illustrated in FIG. 6. As shown in the embodiment of FIG. 6, an omnichannel commerce platform presents to a consumer 660 an ordering environment 680 corresponding to a merchant 650 that is customized at least in part for that consumer 660. In various embodiments, the customization may be based on one or more of the following (including any combination of the following): merchant data received from the data management and analytics layer 620 (e.g., from the merchant data management framework 624), consumer data received from the data management and analytics layer 620 (e.g., from the consumer data management framework 622), vendor data received from the data management and analytics layer 620 (e.g., from the vendor data management framework 626), delivery data received from the data management and analytics layer 620 (e.g., from the deliveries data management framework 628), reservation data received from the data management and analytics layer 620 (e.g., from the reservations data management framework 630), other data received from the data management and analytics layer 620 (e.g., from the other omnichannel data management frameworks 632).

As illustrated in FIG. 3, in various embodiments, a set of consumers, such as consumers 660, 662, 664 and 668, may each receive a customized ordering environment, illustrated as ordering environments 680, 682, 684 and respectively 688, which correspond to the same merchant.

In one embodiment, a merchant may be a restaurant or other food establishment (examples of restaurants include a formal sit-down restaurant, a QSR, etc.) and each consumer may receive a different version of a restaurant menu that presents to each consumer various combinations of one or more of the following: food items, meals, ingredients, modifiers, beverages, images, listing order or ranking, emphasis, presentation, description, comments from consumers or other reviewers, order fulfillment time, delivery options, pickup options, personalized messages for the consumer, prices, digital offers, digital coupons, loyalty offers, and/or payment options.

In one embodiment, a merchant may be a retail store and each consumer may receive a different version of a retail shopping list (e.g., grouped by categories, items, prices, applications, and so on) that presents to each consumer various combinations of one or more of the following: retail items, merchandise items, merchandise attributes, images, listing order or ranking, emphasis, presentation, description, comments from consumers or other reviewers, order fulfillment time, delivery options, pickup options, personalized messages for the consumer, prices, digital offers, digital coupons, loyalty offers, and/or payment options.

In one embodiment, a merchant may be a facility providing services and each consumer may receive a different version of a services shopping list (e.g., grouped by categories, items, prices, applications, and so on) that presents to each consumer various combinations of one or more of the following: services, attributes, images, listing order or ranking, emphasis, presentation, description, comments from consumers or other reviewers, order fulfillment time, delivery options, pickup options, personalized messages for the consumer, prices, digital offers, digital coupons, loyalty offers, and/or payment options.

In one embodiment, one or more of the consumers may receive the same version of the ordering environment corresponding to the merchant, where such version is a default version of the ordering environment. For example, this may occur if the omnichannel commerce platform is unable to retrieve actionable consumer data or merchant data that would facilitate deliberate customization of the ordering environment. In one embodiment, one or more of the consumers may receive the same version of the ordering environment corresponding to the merchant, where such version is a customized version of the ordering environment. For example, this may occur if the omnichannel commerce platform retrieves similar consumer data or merchant data that suggests similar customization of the ordering environment.

In one embodiment, the ordering environment of a merchant is customized for one or more consumers in response to a fee or other consideration paid by the merchant. For example, in various embodiments, the operator of the omnichannel commerce platform may customize the ordering environment of a merchant in exchange for a fee or other consideration paid to the operator by the merchant. Since such customization may lead to additional sales or higher profit margin, a merchant may be willing to pay a fee in exchange for customization of the merchant's ordering environment presented to one or more consumers.

In one embodiment, the ordering environment of a merchant is customized for one or more consumers in response to a fee or other consideration paid by a third party. For example, in various embodiments, the operator of the omnichannel commerce platform may customize the ordering environment of a merchant in exchange for a fee or other consideration paid to the operator by a payment processor, by a vendor of a product or service offered by the merchant, by a delivery company, by a loyalty company, and/or by any other entity that has some nexus with the prospective transaction to be conducted by the consumer. Since such customization may lead to additional sales or a higher profit margin for the third party, the third party may be willing to pay a fee in exchange for customization of the merchant's ordering environment presented to one or more consumers.

In one embodiment, the ordering environment of a merchant is customized for a consumer in response to a fee or other consideration paid by the consumer. Since such customization may lead to a better consumer experience, lower prices, and/or higher value for the consumer, the consumer may be willing to pay a fee or other consideration in exchange for customization of the merchant's ordering environment presented to one or more consumers. Examples of such consideration may include cash, credit or other financial instruments, loyalty points, a positive review on a social networking site or in other media, and/or good will.

In various embodiments, the customization of an ordering environment presented to a consumer may be made by a mobile app shopping platform, and the customized ordering environment may be presented to a mobile data processing system in the possession of a consumer, such as a mobile phone (e.g., presented to an app running on the phone), a wearable device (e.g., a watch, glasses with an electronic display, Google Glass or similar device, etc.), a vehicle navigation system or information system (e.g., a display inside a car or other vehicle in which the consumer is the driver or a passenger), or a tablet (e.g., an iPad, an Android tablet, etc.).

In various embodiments, the customization of an ordering environment presented to a consumer may be made by an online shopping platform, and the customized ordering environment may be presented to a data processing system in the possession of a consumer and adapted to make a purchase over the web, such as a laptop, personal computer, Chromebook, mobile phone (e.g., presented to an app running on the phone), a wearable device (e.g., a watch, glasses with an electronic display, Google Glass or similar device, etc.), a vehicle navigation system or information system (e.g., a display inside a car or other vehicle in which the consumer is the driver or a passenger), a tablet (e.g., an iPad, an Android tablet, etc.), or any other device that may utilize an Internet browser.

In various embodiments, an ordering environment for a restaurant may present to a particular consumer one or more food items accompanied by digital offers or digital coupons issued based on relevant consumer data and/or merchant data. In various embodiments, the price for one or more of the food items displayed to the consumer may be adjusted based on relevant consumer data and/or merchant data. For example, it may be in the interest of the merchant to sell more of a food item if it is likely that the respective food item may be left over at the end of the day and therefore be spoiled, so the price for that food item may be decreased dynamically or the amount of a corresponding coupon or offer may be increased. As another example, one food item or retail article may be in short supply, or an ingredient needed for a food item may be in short supply, so the price for that food item or retail article may be increased dynamically.

As another example, in various embodiments, the omnichannel commerce platform may be aware based on relevant consumer data and/or merchant data that one or more consumers (including possibly consumers different from the consumer under consideration currently) are conducting searches via a mobile app shopping platform or via an online shopping platform for a particular food item, retail article or service, and that such food item, retail article or service may be in short supply in a particular geographic area, so the omnichannel commerce platform may present a higher price for that particular food item, retail article or service in the ordering environment presented to a consumer.

As another example, in various embodiments, the omnichannel commerce platform may be aware based on relevant vendor data (e.g., vendor data received from a vendor data management framework such as the vendor data management framework 626 illustrated in FIG. 6, the vendor data management framework 326 illustrated in FIG. 3, or the vendor data management framework 126 illustrated in FIG. 1) that a particular food item, retail article or service may be in short supply now may become in short supply in the future. In one embodiment, the omnichannel commerce platform may decide that a particular food item, retail article or service may become in short supply in the future because of an imbalance between the inventory available to the supply chain vendors and the current or predicted merchant demand. In one embodiment, the omnichannel commerce platform may decide that a particular food item, retail article or service may become in short supply in the future because of an imbalance between the inventory available to the supply chain vendors and the current or predicted consumer demand. In one embodiment, the omnichannel commerce platform may decide that a particular food item, retail article or service may become in short supply in the future because of a current or anticipated supply chain disruption. In such cases, in various embodiments, the omnichannel commerce platform (e.g., through the mobile app shopping platform of a merchant) may present a higher price for that particular food item, retail article or service in the ordering environment presented to a consumer. This is an example of dynamic price adjustment in response to relevant consumer data, merchant data, and/or vendor data.

As another example, in various embodiments, the omnichannel commerce platform may be aware based on relevant vendor data (e.g., vendor data received from a vendor data management framework such as the vendor data management framework 626 illustrated in FIG. 6, the vendor data management framework 326 illustrated in FIG. 3, or the vendor data management framework 126 illustrated in FIG. 1) that a particular food item, retail article or service may be facing oversupply conditions currently, or is likely to be exceed demand in the future. In one embodiment, the omnichannel commerce platform may decide that a particular food item, retail article or service may exceed demand in the future because of a mismatch between the inventory available to the supply chain vendors and the current or predicted merchant demand. In one embodiment, the omnichannel commerce platform may decide that a particular food item, retail article or service may exceed demand in the future because of an imbalance between the inventory available to the supply chain vendors and the current or predicted consumer demand. In one embodiment, the omnichannel commerce platform may decide that a particular food item, retail article or service may exceed demand in the future because of a current or anticipated supply chain distortions (e.g., excessive manufacturing by one or more suppliers). In such cases, in various embodiments, the omnichannel commerce platform (e.g., through the mobile app shopping platform of a merchant) may present a lower price for that particular food item, retail article or service in the ordering environment presented to a consumer. This is an example of dynamic price adjustment in response to relevant consumer data, merchant data, and/or vendor data, in accordance with an embodiment.

As another example, in various embodiments, the omnichannel commerce platform may be aware based on relevant consumer data and/or merchant data that a particular consumer may be less sensitive or more sensitive to price, so the omnichannel commerce platform may present a higher price or respectively lower price for one or more food items, retail articles or services in the ordering environment presented to that consumer.

As another example, in various embodiments, the omnichannel commerce platform may be aware based on relevant consumer data and/or merchant data that a particular consumer may be less sensitive or more sensitive to geographic location, distance, pickup delay, pickup time, delivery delay, delivery time, decision whether to pick up or request delivery, bundling of multiple items, articles or services, shipping charges, delivery method, pickup location, packaging type, and so on, and consequently may accordingly customize the presentation of the merchant location or locations available to the consumer, the pickup delay, pickup time, delivery delay, delivery time, option whether to pick up or request delivery, bundling of multiple food items, retail articles or services, the amount or waiver of shipping charges, delivery method, pickup location, delivery location, and packaging type with respect to food items, retail articles or services presented to that consumer in an ordering environment.

As another example, in various embodiments, the omnichannel commerce platform may be aware based on relevant consumer data and/or merchant data that a particular consumer may be less sensitive or more sensitive to graphical presentation of food items, retail articles or services, and may consequently customize the ordering environment presented to that user by accordingly presenting less or more pictures, videos or graphical symbols.

As another example, the omnichannel commerce platform may have limited or no information about a consumer's preferences relative to a particular merchant or merchant segment. In such a situation, in various embodiments, the omnichannel commerce platform may utilize unrelated consumer data and/or merchant data to customize the ordering environment presented to that user (e.g., historical consumer data indicating that this consumer preferred pickup for a retail item in a previous retail purchase may be used to emphasize pickup options for food from a restaurant presented to the consumer). In various embodiments, the omnichannel commerce platform may not customize the ordering environment presented to a user, and therefore may present to the user a default ordering environment.

In various embodiments, an ordering environment may be customized for a consumer in response to a rule or other request made by a merchant or by a third party. For example, a merchant or a third party (e.g., payment processor, vendor, supplier, loyalty company, etc.) may implement rules that request the omnichannel commerce platform and/or an app running on the consumer's data processing system to customize an ordering environment based one or more of the following (including any combination of the following): time of day, day of week, during certain time windows, season, geographic location of the consumer, direction of travel of the consumer, recent purchasing behavior of consumer, recent behavior of consumer, calendar or predicted schedule of the consumer (e.g., projected travel in an area, projected meeting of one or more other persons, etc.), condition of an object (e.g., the need to refuel or recharge a vehicle, malfunction of hardware device of software program used by the consumer or by another individual associated with the consumer, etc.), current or predicted consumer traffic or ordering traffic for that merchant (e.g., no or lower customization when a merchant's facility is busy, higher customization when a merchant's store does not have enough customers or orders, etc.), vendor data (e.g., information that one or more food items, retail items or services from the supply chain are in short supply or exceed demand), volume of actual or predicted orders for one or more food items, retail items or services based on actual or predicted behavior of consumers (e.g., a higher level of searches performed by consumers for a particular item or service observed by the omnichannel commerce platform may lead to lower or higher customization), and so on.

In general, in various embodiments, based on the consumer data relating to a merchant (e.g., merchant 650) and/or based on consumer data related to a set of consumers (e.g., the consumers 660, 662, 664, and 668), the omnichannel commerce platform 600 may present an ordering environment related to the merchant that is customized for one, some or all of the consumers.

In various embodiments, various transactions and activities discussed above in connection with the embodiment of FIG. 6 may involve transactions or communications involving a blockchain or combination of blockchains, illustrated in FIG. 6 as blockchain 696. In various embodiments, such transactions may involve purchases or sales of goods or services, the transmission of funds, the receipt of funds, credits, debits, the purchase or sale of commerce data, the redemption or accumulation of loyalty credits and/or smart contracts made using one or more cryptocurrencies and/or one or more types of cryptographic tokens, as further described in connection with the embodiment of FIG. 1. Blockchains, cryptocurrencies, cryptographic tokens and smart contracts were discussed in more detail in connection with the embodiment of FIG. 1. In various embodiments, the blockchain 696 may represent the blockchain 196 discussed in connection with the embodiment of FIG. 1. In various embodiments, the blockchain 696 may facilitate commerce transactions, activities, incentives, rewards, and/or smart contracts involving cryptocurrencies and/or cryptographic tokens, as generally described in connection with the embodiment of FIG. 1.

In various embodiments, transactions involving one or more consumers 660, 662, 664 and/or 668, one or more merchants 650, the omnichannel layer 602 (and/or any platform included in the omnichannel layer 602), the data management and analytics layer 620 (and/or any framework included in the data management and analytics layer 620), and/or the API layer 690, as discussed in connection with the embodiment of FIG. 6, may involve one or more blockchains (illustrated by the blockchain 696), one or more cryptocurrencies, one or more types of cryptographic tokens, and/or one or more smart contracts, as generally discussed in connection with the embodiment of FIG. 1.

In various embodiments, transactions involving one or more consumers 660, 662, 664 and/or 668, one or more merchants 650, the omnichannel layer 602 (and/or any platform included in the omnichannel layer 602), the data management and analytics layer 620 (and/or any framework included in the data management and analytics layer 620), and/or the API layer 690, as discussed in connection with the embodiment of FIG. 6, may involve purchases or sales of goods or services, the transmission of funds, the receipt of funds, credits, debits, the purchase or sale of commerce data, the redemption or accumulation of loyalty credits and/or smart contracts made using one or more cryptocurrencies and/or one or more types of cryptographic tokens, as further described in connection with the embodiment of FIG. 1.

FIG. 7 shows an omnichannel commerce platform adapted to process and transmit commerce data and/or commerce data analytics to one or more data customers, in accordance with an embodiment. In the embodiment of FIG. 7, the omnichannel commerce platform is illustrated by omnichannel commerce platform 700, and the commerce data is illustrated as commerce data 780.

In the embodiment of FIG. 7, the omnichannel commerce platform 700 includes an omnichannel layer 702, a data management and analytics layer 720 and an API layer 790. Various platforms and data management platforms included in the omnichannel layer 702 and respectively data management and analytics layer 720 are shown in FIG. 7 and in various embodiments may be similar to those discussed in connection with FIG. 1 and FIG. 3.

In the embodiment of FIG. 7, commerce data, KPIs and other analytics based on commerce data are transmitted from the data management and analytics layer 720 to one or more data customers 756 via an API layer 790 and/or via direct communication channels or one or more data networks. In various embodiments, one or more data customers may receive commerce data that includes consumer data, merchant data, vendor data, deliveries data, reservations data, other omnichannel data and/or KPIs from one or more of the following: a consumer data management framework, merchant data management framework, vendor data management framework, deliveries data management framework, reservations data management framework, one or more of the other omnichannel data frameworks, and/or a KPIs and reporting framework.

In various embodiments, the commerce data, KPIs and other analytics based on commerce data that are transmitted from the data management and analytics layer 720 to one or more data customers may be organized by, or may include data for one or more of the following (including any combination of the following): merchant, SMB location, Enterprise, set of Enterprise locations, street, mall, other grouping of merchants, neighborhood, zip code, city, county, municipality, state, country, continent, other geographical area, date, time, season, attribute of merchant (e.g., size, transaction volume, sales volume, type of business, number of employees, type of employees, etc.), business segment (e.g., food service, retail, services, hospitality (e.g., hotels, lodging, etc.), rental of vehicles or equipment, entertainment, sports, grocery, bar, etc.), payment processor information, other merchant data, other consumer data, and/or other vendor data.

In various embodiments, data customers that receive commerce data and/or commerce data analytics from the data management and analytics layer may include a Governmental agency or other Governmental entity. In various embodiments, such a Governmental agency or entity may receive tax data included in the commerce data (e.g., automatic tax reporting for sales taxes or other taxes collected or scheduled to be collected by one or more merchants, automatic tax reporting for sales taxes, use taxes or other taxes paid or scheduled to be paid by one or more consumers. merchants, or vendors, etc.). In one embodiment, a Governmental agency or entity may receive commerce data that includes SKU-level transaction data and/or aggregated and anonymized data that can be used to better understand economic trends, evaluate consumer behavior, evaluate demand for products or services, compute economic indexes and metrics with higher accuracy, and set more accurate monetary policy.

In various embodiments, data customers that receive commerce data and/or commerce data analytics from the data management and analytics layer may include institutional investors or other entities involved in investment brokerage, financial advisory services, investment banking, equity investments, analysts, and other financial entities. In various embodiments, such investors or entities may receive commerce data that includes SKU-level transaction data and/or aggregated and anonymized data that can be used to better understand economic trends, evaluate consumer behavior, evaluate demand for products or services, compute economic indexes and metrics with higher accuracy, anticipate macro-economic trends, improve market and investment models, improve pricing decisions, etc.

In various embodiments, data customers that receive commerce data and/or commerce data analytics from the data management and analytics layer may include point of sale companies and business intelligence companies (e.g., companies involved in consulting or business optimization). In various embodiments, such point of sale companies and business intelligence companies may receive commerce data that includes SKU-level transaction data and/or aggregated and anonymized data that can be used to evaluate consumer behavior, evaluate demand for products or services, enhance and augment consumer data and/or merchant data in their possession, improve product and service offerings, improve pricing decisions, etc.

In various embodiments, data customers that receive commerce data and/or commerce data analytics from the data management and analytics layer may include loyalty companies, reservations companies, and other commerce companies (e.g., other companies involved in various aspects of the omnichannel commerce space). In various embodiments, such loyalty companies, reservations companies, and other commerce companies may receive commerce data that includes SKU-level transaction data and/or aggregated and anonymized data that can be used to evaluate consumer behavior, evaluate demand for products or services, enhance and augment consumer data and/or merchant data in their possession, improve product and service offerings, improve pricing decisions, etc.

In various embodiments, data customers that receive commerce data and/or commerce data analytics from the data management and analytics layer may include payment processors and other financial entities (e.g., banks and other entities involved in various aspects of the financial industry). In various embodiments, such payment processors and other financial entities may receive commerce data that includes SKU-level transaction data and/or aggregated and anonymized data that can be used to evaluate consumer behavior, evaluate demand for products or services, enhance and augment consumer data and/or merchant data in their possession, improve product and service offerings, better understand economic trends, anticipate macro-economic trends, improve market and financial models, improve pricing decisions, etc.

In various embodiments, data customers that receive commerce data and/or commerce data analytics from the data management and analytics layer may include vendors and other companies involved in the supply chain (e.g., manufacturers and distributors of food items, ingredients, beverages, retail articles, materials, services, industrial equipment, etc.). In various embodiments, such vendors and other companies involved in the supply chain may receive commerce data that includes SKU-level transaction data and/or aggregated and anonymized data that can be used to evaluate consumer behavior, evaluate demand for products or services, enhance and augment consumer data and/or merchant data in their possession, improve product and service offerings, anticipate inventory demand, optimize product mix, improve pricing decisions, etc.

In various embodiments, data customers that receive commerce data and/or commerce data analytics from the data management and analytics layer may include merchants. In various embodiments, such merchants may receive commerce data that includes SKU-level transaction data and/or aggregated and anonymized data that can be used to evaluate consumer behavior, evaluate demand for products or services, enhance and augment consumer data and/or merchant data in their possession, improve product and service offerings, anticipate inventory demand, optimize product mix, improve pricing decisions, drive consumer demand, increase sales, increase profit margins, improve business intelligence and KPIs, improve CRM data, anticipate consumer demand, etc.

In various embodiments, the omnichannel commerce platform 700 would hold detailed commerce data (e.g., SKU-level data may be held in the data management and analytics layer 720), which would be of interest to any entity that seeks to understand detailed shopping preferences of individual consumers and/or to predict behavioral patterns of such consumers. Such data, however, could also be used (e.g., in raw form, in aggregated form, etc.) to ascertain economic trends (e.g., increase in consumer spending, increased economic activity, etc.), determine geographic business variations (e.g., regional increases or decreases in economic activity, etc.), increase the accuracy of traditional Governmental economic metrics (e.g., inflation index, economic expansion, etc.), and so on.

In various embodiments, a multitude of private and Governmental entities, including merchants, product manufacturers, payment processors, Governmental entities, and so on, would be interested in becoming data customers and purchasing commerce data. Such purchases may be made using one or more classic currencies, one or more cryptographic currencies and/or one or more types of cryptographic tokens.

In various embodiments, some of these entities may also hold commerce data themselves that is of interest to the operator of the omnichannel commerce platform 700, or to other entities operating on the Tyme Commerce platform, so some of these entities may also sell commerce data to the operator of the omnichannel commerce platform 700 or to other entities. Such sales may be made using one or more classic currencies, one or more cryptographic currencies and/or one or more types of cryptographic tokens.

In various embodiments, the price of commerce data being purchased or sold may vary dynamically, depending on various factors such as the type of data being purchased (e.g., personal data, v. aggregated data), the novelty of the data (e.g., a new batch of data unknown to the buyer v. data related to known consumers for which the buyer already holds some information), the format of the data (e.g., raw data v. structured data), the source of the data (e.g., data collected by the seller v. data collected by a third party), the date and time, the location of the data (e.g., country of seller, country of buyer, country/region of the consumers for which data is being sold), how data was generated (e.g., whether the data was generated as part of a consumer purchase transaction v. data collected later), and so on. The appropriate amount, denominated in one or more classic currencies, one or more cryptographic currencies and/or one or more types of cryptographic tokens, could be automatically transferred to the seller to pay for such data, possibly using smart contracts, through the blockchain layer.

In various embodiments, various transactions and activities discussed above in connection with the embodiment of FIG. 7 may involve transactions or communications involving a blockchain or combination of blockchains, illustrated in FIG. 7 as blockchain 796. In various embodiments, such transactions may involve purchases or sales of goods or services, the transmission of funds, the receipt of funds, credits, debits, the purchase or sale of commerce data, the redemption or accumulation of loyalty credits and/or smart contracts made using one or more cryptocurrencies and/or one or more types of cryptographic tokens, as further described in connection with the embodiment of FIG. 1. Blockchains, cryptocurrencies, cryptographic tokens and smart contracts were discussed in more detail in connection with the embodiment of FIG. 1. In various embodiments, the blockchain 796 may represent the blockchain 196 discussed in connection with the embodiment of FIG. 1. In various embodiments, the blockchain 796 may facilitate commerce transactions, activities, incentives, rewards, and/or smart contracts involving cryptocurrencies and/or cryptographic tokens, as generally described in connection with the embodiment of FIG. 1.

In various embodiments, transactions involving one or more consumers 760, one or more merchants 750, one or more data customers 756, the omnichannel layer 702 (and/or any platform included in the omnichannel layer 702), the data management and analytics layer 720 (and/or any framework included in the data management and analytics layer 720), and/or the API layer 790, as discussed in connection with the embodiment of FIG. 7, may involve one or more blockchains (illustrated by the blockchain 796), one or more cryptocurrencies, one or more types of cryptographic tokens, and/or one or more smart contracts, as generally discussed in connection with the embodiment of FIG. 1.

In various embodiments, transactions involving one or more consumers 760, one or more merchants 750, one or more data customers 756, the omnichannel layer 702 (and/or any platform included in the omnichannel layer 702), the data management and analytics layer 720 (and/or any framework included in the data management and analytics layer 720), and/or the API layer 790, as discussed in connection with the embodiment of FIG. 7, may involve purchases or sales of goods or services, the transmission of funds, the receipt of funds, credits, debits, the purchase or sale of commerce data, the redemption or accumulation of loyalty credits and/or smart contracts made using one or more cryptocurrencies and/or one or more types of cryptographic tokens, as further described in connection with the embodiment of FIG. 1.

FIG. 8 shows an omnichannel commerce platform adapted to process a commerce transaction between a consumer and a merchant by selecting a payment processor from a set of payment processors, in accordance with an embodiment. In the embodiment of FIG. 8, the omnichannel commerce platform is illustrated by omnichannel commerce platform 800, the consumer is illustrated as consumer 860, and the merchant is illustrated as merchant 850, and the payment processors are illustrated as payment processor 852 and payment processor 854.

In the embodiment of FIG. 8, the omnichannel commerce platform 800 includes an omnichannel layer 802, a data management and analytics layer 820 and an API layer 890. Various platforms and data management platforms included in the omnichannel layer 802 and respectively data management and analytics layer 820 are shown in FIG. 8 and in various embodiments may be similar to those discussed in connection with FIG. 1 and FIG. 3.

In the embodiment of FIG. 8, a consumer 860 conducts a commerce transaction (e.g., a purchase or lease of a product or retail item, a purchase of a food item or beverage item, a payment for a service, etc.) from a merchant 850. The commerce transaction may involve, in various embodiments, one or more of the following, including any combination of the following: a food or beverage item, a retail item, digital content, a service, a rental, and/or any other type of product or service that can be purchased, leased or otherwise obtained in exchange for a payment. Ordering and purchases made by consumes from merchants were discussed in more detail in connection with the embodiments of FIG. 1, FIG. 3, FIG. 4, FIG. 5 and FIG. 6.

In the embodiment of FIG. 8, the omnichannel commerce platform 800 (e.g. the online shopping platform 804, the mobile app shopping platform 806, etc.) and/or the data processing system in possession of the consumer 860 (e.g., an app running on the a mobile phone of the consumer, an application running on a computer of the consumer, etc.) have the option to select one or more payment processors from a plurality of payment processors to route the payment for one or more transactions conducted by the consumer 860.

In one embodiment, consumer 860 completes a commerce transaction with a merchant 850, which includes a payment made by the consumer to the merchant, and the payment is routed to a particular payment processor based on one or more of the following (including any combination of the following): a fee or other consideration paid by the payment processor to the merchant, a fee or other consideration paid by the payment processor to the operator of the omnichannel commerce platform,

In various embodiments, an operator of the omnichannel commerce platform may receive various fees or other consideration in connection with transactions processed by various aspects of the omnichannel platform. In response to such fees or other consideration, in various embodiments, the operator of the omnichannel commerce platform may alter the functionality of the omnichannel commerce platform and/or of the data processing systems used by consumers. In response to such fees or other consideration, in various embodiments, the operator of the omnichannel commerce platform may alter the flow and outcome of transactions conducted by and between consumers, merchants, vendors, loyalty companies, payment processors, data customers, reservations companies, digital coupons vendors or processors, digital offers vendors or processors, point of sale companies, and other entities involved in omnichannel transactions. In response to such fees or other consideration, in various embodiments, the operator of the omnichannel commerce platform may customize to various degrees and in various ways the ordering environment presented to one or more consumers for a merchant.

In various embodiments, in response to a payment or other consideration received by a merchant and/or by an operator of the omnichannel commerce platform, the operator of the omnichannel commerce platform and/or the data processing system of a consumer may route to a particular payment processor the payment for a transaction between a consumer and a merchant. As a result of this routing, the respective payment processor may process the transaction and collect a corresponding transaction fee.

In various embodiments, one or more commerce transactions between a consumer and a merchant are routed to a particular payment processor in response to a dynamic bidding or offer made by that payment processor relative to other payment processors. For example, a plurality of payment processors may bid to process one or more payment transactions from a consumer and/or from a merchant, and the payment processor that makes the most compelling offer in terms of fees or other consideration wins the right to process the respective one or more transactions. In one embodiment, the bidding by payment processors and the routing of the one or more transactions occur automatically and substantially without the intervention of humans. In one embodiment, the bidding by payment processors and the routing of the one or more transactions occur automatically and substantially without the intervention of humans, and the bidding is evaluated automatically by an omnichannel commerce platform, by an app or application running on a data processing system of a consumer, or by one or more platforms and/or data management frameworks included in the omnichannel commerce platform.

In various embodiments, the “operator of the omnichannel commerce platform” may be an entity that overall controls the operation of all, or substantially all of the omnichannel commerce platform. For example, the operator of the omnichannel commerce platform may be an entity that leases to, licenses to, or operates for merchants various instances of an omnichannel layer, operates various instances of a data management and analytics layer, licenses or otherwise controls various apps or applications running on consumer data processing systems, and/or operates various instances of an API layer.

In various embodiments, the “operator of the omnichannel commerce platform” may mean an entity that controls only a portion of the omnichannel commerce platform (e.g., one or more platforms included in an omnichannel layer, one or more data frameworks included in a data management and analytics layer, etc.), provided that such portion impacts the behavior of the omnichannel commerce platform relevant to one or more merchants, consumers, vendors, and/or third parties. In various embodiments, an entity that controls the online shopping platform relevant to a merchant may influence the operation of that online shopping platform for transactions made with or by that merchant, such as customization of an ordering environment for that merchant. In various embodiments, an entity that controls the mobile app shopping platform relevant to a merchant may influence the operation of that mobile app shopping platform for transactions made with or by that merchant, such as customization of an ordering environment for that merchant. In various embodiments, an entity that controls the online shopping platform relevant to a merchant may be the merchant itself, a loyalty company, a point of sale company, a payment processor, and/or another company involved in the omnichannel space.

In various embodiments, the payment processor that processes the payment for the commerce transaction may or may not be affiliated with the merchant. In various embodiments, whether or not a payment processor has a pre-existing relationship with a merchant is used as a criterion when deciding whether to route to that payment processor the payment for a commerce transaction involving that merchant.

In one embodiment, at least one of the payment processors 852 and 854 has a pre-existing payment processing relationship with the merchant 850. In one embodiment, because of this preexisting relationship, the payment for a purchase transaction made by a consumer 860 from the merchant 850 is automatically routed to that payment processor. In one embodiment, because of this preexisting relationship, the payment for a purchase transaction made by a consumer 860 from the merchant 850 is more likely to be routed to that payment processor. In one embodiment, because of this preexisting relationship, the payment for a purchase transaction made by a consumer 860 from the merchant 850 is less likely to be routed to that payment processor. In one embodiment, because of this preexisting relationship, the payment for a purchase transaction made by a consumer 860 from the merchant 850 is automatically routed to a different payment processor. In one embodiment, this preexisting relationship has no effect on the selection of the payment processor for a purchase transaction made by a consumer 860 from the merchant 850.

In one embodiment, a payment processor 852 does not have a pre-existing payment processing relationship with the merchant 850. In one embodiment, because of the lack of a preexisting relationship, the payment for a purchase transaction made by a consumer 860 from the merchant 850 is automatically routed to that payment processor. In one embodiment, because of the lack of a preexisting relationship, the payment for a purchase transaction made by a consumer 860 from the merchant 850 is more likely to be routed to that payment processor. In one embodiment, because of the lack of a preexisting relationship, the payment for a purchase transaction made by a consumer 860 from the merchant 850 is less likely to be routed to that payment processor. In one embodiment, because of the lack of a preexisting relationship, the payment for a purchase transaction made by a consumer 860 from the merchant 850 is automatically routed to a different payment processor. In one embodiment, the lack of a preexisting relationship between a merchant and a payment processor has no effect on the selection of the payment processor for a purchase transaction made by a consumer 860 from the merchant 850.

In one embodiment, a preexisting relationship between a payment processor 852 and a merchant 850 increases the bidding threshold needed by a payment processor 854 in competition with the payment processor 852 to win the processing for a payment transaction conducted by the consumer 860 from the merchant 850. In one embodiment, the lack of a preexisting relationship between a payment processor 852 and a merchant 850 decreased the bidding threshold needed by a payment processor 854 in competition with the payment processor 852 to win the processing for a payment transaction conducted by the consumer 860 from the merchant 850.

In various embodiments, various transactions and activities discussed above in connection with the embodiment of FIG. 8 may involve transactions or communications involving a blockchain or combination of blockchains, illustrated in FIG. 8 as blockchain 896. In various embodiments, such transactions may involve purchases or sales of goods or services, the transmission of funds, the receipt of funds, credits, debits, the purchase or sale of commerce data, the redemption or accumulation of loyalty credits and/or smart contracts made using one or more cryptocurrencies and/or one or more types of cryptographic tokens, as further described in connection with the embodiment of FIG. 1. Blockchains, cryptocurrencies, cryptographic tokens and smart contracts were discussed in more detail in connection with the embodiment of FIG. 1. In various embodiments, the blockchain 896 may represent the blockchain 196 discussed in connection with the embodiment of FIG. 1. In various embodiments, the blockchain 896 may facilitate commerce transactions, activities, incentives, rewards, and/or smart contracts involving cryptocurrencies and/or cryptographic tokens, as generally described in connection with the embodiment of FIG. 1.

In various embodiments, transactions involving one or more consumers 860, one or more merchants 850, one or more payment processors 852 and/or 854, one or more data customers 856, the omnichannel layer 802 (and/or any platform included in the omnichannel layer 802), the data management and analytics layer 820 (and/or any framework included in the data management and analytics layer 820), and/or the API layer 890, as discussed in connection with the embodiment of FIG. 8, may involve one or more blockchains (illustrated by the blockchain 896), one or more cryptocurrencies, one or more types of cryptographic tokens, and/or one or more smart contracts, as generally discussed in connection with the embodiment of FIG. 1.

In various embodiments, transactions involving one or more consumers 860, one or more merchants 850, one or more payment processors 852 and/or 854, one or more data customers 856, the omnichannel layer 802 (and/or any platform included in the omnichannel layer 802), the data management and analytics layer 820 (and/or any framework included in the data management and analytics layer 820), and/or the API layer 890, as discussed in connection with the embodiment of FIG. 8, may involve purchases or sales of goods or services, the transmission of funds, the receipt of funds, credits, debits, the purchase or sale of commerce data, the redemption or accumulation of loyalty credits and/or smart contracts made using one or more cryptocurrencies and/or one or more types of cryptographic tokens, as further described in connection with the embodiment of FIG. 1.

This specification describes in detail various embodiments and implementations of the present invention, and the present invention is open to additional embodiments and implementations, further modifications, and alternative and/or complementary constructions. There is no intention in this patent to limit the invention to the particular embodiments and implementations disclosed; on the contrary, this patent is intended to cover all modifications, equivalents and alternative embodiments and implementations that fall within the scope of the claims.

As used in this specification, a set means any group of one, two or more items. Analogously, a subset means, with respect to a set of N items, any group of such items consisting of N−1 or less of the respective N items.

In general, unless otherwise stated or required by the context, when used in this patent in connection with a method or process, data processing system, or logic module, the words “adapted” and “configured” are intended to describe that the respective method, data processing system or logic module is capable of performing the respective functions by being appropriately adapted or configured (e.g., via programming, via the addition of relevant components or interfaces, etc.), but are not intended to suggest that the respective method, data processing system or logic module is not capable of performing other functions. For example, unless otherwise expressly stated, a logic module that is described as being adapted to process a specific class of information will not be construed to be exclusively adapted to process only that specific class of information, but may in fact be able to process other classes of information and to perform additional functions (e.g., receiving, transmitting, converting, or otherwise processing or manipulating information).

As used in this specification, the terms “include,” “including,” “for example,” “exemplary,” “e.g.,” and variations thereof, are not intended to be terms of limitation, but rather are intended to be followed by the words “without limitation” or by words with a similar meaning. Definitions in this specification, and all headers, titles and subtitles, are intended to be descriptive and illustrative with the goal of facilitating comprehension, but are not intended to be limiting with respect to the scope of the inventions as recited in the claims. Each such definition is intended to also capture additional equivalent items, technologies or terms that would be known or would become known to a person of average skill in this art as equivalent or otherwise interchangeable with the respective item, technology or term so defined. Unless otherwise required by the context, the verb “may” or “could” indicates a possibility that the respective action, step or implementation may or could be achieved, but is not intended to establish a requirement that such action, step or implementation must occur, or that the respective action, step or implementation must be achieved in the exact manner described.

What is claimed is:

1. An omnichannel commerce platform comprising:
an omnichannel layer adapted to facilitate a commerce transaction between a merchant and a data processing system in possession of a consumer;
a data management and analytics layer that stores commerce data; and
a blockchain layer;
wherein the omnichannel layer and the data management and analytics layer are connected to each other and are each connected to an API layer;
wherein at least one of the omnichannel layer and the data management and analytics layer is adapted to make the commerce data available to be used in the course of the commerce transaction;
and wherein at least one cryptocurrency or at least one type of cryptographic token is used in connection with the commerce transaction.

2. The omnichannel commerce platform of claim 1, wherein the omnichannel layer, the data management and analytics layer and the data processing system are adapted to communicate with each other via the API layer, via a network, or via a combination of the API layer and a network.

3. The omnichannel commerce platform of claim 1, wherein at least one of the omnichannel layer, the data management and analytics layer, and the blockchain layer is adapted to update at least a subset of the commerce data based on the commerce transaction.

4. The omnichannel commerce platform of claim 1, wherein the omnichannel layer is adapted to receive from the data management and analytics layer and/or from the data processing system a set of consumer data relating to the consumer.

5. The omnichannel commerce platform of claim 1, wherein the commerce transaction includes a payment made via a credit card or debit card, and the omnichannel commerce platform is adapted to route the payment to a payment processor.

6. The omnichannel commerce platform of claim 5, wherein the payment processor does not have a pre-existing relationship with the merchant.

7. The omnichannel commerce platform of claim 1, wherein the commerce transaction includes a payment made via at least one cryptocurrency and/or at least one type of cryptographic token, and wherein such payment is processed through the blockchain layer.

8. The omnichannel commerce platform of claim 1, wherein the omnichannel layer includes a mobile app shopping platform, the mobile app shopping platform is adapted to facilitate the commerce transaction, and the data processing system in possession of the consumer is any of the following:
a mobile phone running an app, including any mobile phone that utilizes an iOS, Android, or Windows operating system;
an electronic tablet running an app, including any electronic tablet that utilizes an iOS, Android, or Windows operating system;
a wearable device running an app, including an electronic watch with a digital display, or an electronic eyewear device;
a vehicle entertainment system running an app, vehicle navigation system, or vehicle information system; or
a laptop or other personal computer running an app.

9. The omnichannel commerce platform of claim 1, wherein the omnichannel layer includes an online shopping platform, the online shopping platform is adapted to facilitate the commerce transaction, and the data processing system in possession of the consumer may be any of the following:
a mobile phone running an app or a browser adapted to communicate with the online shopping platform, including any mobile phone that utilizes an iOS, Android, or Windows operating system;
an electronic tablet running an app or a browser adapted to communicate with the online shopping platform, including any electronic tablet that utilizes an iOS, Android, or Windows operating system;
a wearable device running an app or a browser adapted to communicate with the online shopping platform, including an electronic watch with a digital display, or an electronic eyewear device;
a vehicle entertainment system running an app or a browser adapted to communicate with the online shopping platform, vehicle navigation system, or vehicle information system; or
a laptop or other personal computer running an app or a browser adapted to communicate with the online shopping platform.

10. The omnichannel commerce platform of claim 1, wherein the commerce data may include any of the following:
consumer data;
merchant data;
vendor data;
deliveries data;
reservations data;
other omnichannel data;
cryptocurrency data;
cryptographic token data; or
key performance indicators (KPIs) and other analytics based on any of the foregoing.

11. The omnichannel commerce platform of claim 1, wherein the commerce transaction may include one or more of the following:
purchase or sale of a food item or beverage item;
purchase or sale of a retail item;
purchase or sale of fuel for a vehicle, including gasoline, natural gas, liquefied natural gas, Hydrogen, or a fuel cell;
charging of an electric or hybrid vehicle;
purchase or sale of an item in a grocery store;
a rental transaction from a hotel or other lodging facility;
rental of a car or other vehicle;
purchase or sale of a ticket for travel;
purchase or sale of a ticket for an event;
a transaction involving a service provided by a Governmental agency;
purchase or sale of a good or service using at least one cryptocurrency or at least one type of cryptographic token;
purchase or sale of commerce data relating to at least one consumer and/or at least one commerce transaction, where payment for such purchase or sale is made using at least one cryptocurrency or at least one type of cryptographic token;
redemption of a loyalty credit and/or granting of a loyalty credit, wherein such loyalty credit is denominated in at least one cryptocurrency or at least one type of cryptographic token;
incentivizing an action of a consumer in exchange for a payment or credit denominated in at least one cryptocurrency or at least one type of cryptographic token; or
a bank transaction.

12. A method for conducting a commerce transaction between a merchant and a data processing system in possession of a consumer, wherein:
the transaction uses an omnichannel commerce platform;
the omnichannel commerce platform includes an omnichannel layer and a blockchain layer adapted to facilitate the commerce transaction and a data management and analytics layer that stores commerce data;
the omnichannel layer and the data management and analytics layer are connected to each other and are each connected to an API layer; and
wherein the commerce data is used in connection with the commerce transaction and
wherein at least one cryptocurrency or at least one type of cryptographic token is used in connection with the commerce transaction.

13. The method of claim 12, wherein the commerce data used in connection with the commerce transaction is received via the API layer, via a network, via the blockchain layer, or via a combination of the API layer, the blockchain layer and a network.

14. The method of claim 12, wherein at least a subset of the commerce data is updated based on the commerce transaction.

15. The method of claim 12, wherein the omnichannel layer receives in connection with the commerce transaction a set of consumer data relating to the consumer from the data management and analytics layer and/or from the data processing system.

16. The method of claim 12, wherein the commerce transaction includes routing a payment made via a credit card or debit card to a payment processor, or a payment made using at least one cryptocurrency or at least one type of cryptographic token.

17. The omnichannel commerce platform of claim 16, wherein the payment processor does not have a pre-existing relationship with the merchant.

18. The method of claim 12, wherein the commerce transaction is conducted via a mobile app shopping platform included in the omnichannel layer, and the data processing system in possession of the consumer is any of the following:
a mobile phone running an app, including any mobile phone that utilizes an iOS, Android, or Windows operating system;
an electronic tablet running an app, including any electronic tablet that utilizes an iOS, Android, or Windows operating system;
a wearable device running an app, including an electronic watch with a digital display, or an electronic eyewear device;
a vehicle entertainment system running an app, vehicle navigation system, or vehicle information system; or
a laptop or other personal computer running an app.

19. The method of claim 12, wherein the commerce transaction is conducted via an online shopping platform included in the omnichannel layer, and the data processing system in possession of the consumer may be any of the following:
a mobile phone running an app or a browser adapted to communicate with the online shopping platform, including any mobile phone that utilizes an iOS, Android, or Windows operating system;
an electronic tablet running an app or a browser adapted to communicate with the online shopping platform, including any electronic tablet that utilizes an iOS, Android, or Windows operating system;
a wearable device running an app or a browser adapted to communicate with the online shopping platform, including an electronic watch with a digital display, or an electronic eyewear device;
a vehicle entertainment system running an app or a browser adapted to communicate with the online shopping platform, vehicle navigation system, or vehicle information system; or
a laptop or other personal computer running an app or a browser adapted to communicate with the online shopping platform.

20. The method of claim 12, wherein the commerce data includes one or more of the following:
consumer data;
merchant data;
vendor data;
deliveries data;
reservations data;
other omnichannel data;
cryptocurrency data;
cryptographic token data; or
key performance indicators (KPIs) and other analytics based on any of the foregoing.
